(19) United States
(12) Patent Application Publication
(10) Pub. No.: US 2015/0315043 A1
(43) Pub. Date: Nov. 5, 2015

(54) APPARATUS AND CORRESPONDING METHOD FOR PURIFYING A FLUID

(71) Applicant: IDROPAN DELL'ORTO DEPURATORI S.R.L., Milano (IT)

(72) Inventor: Tullio SERVIDA, Milano (IT)

(21) Appl. No.: 14/648,712

(22) PCT Filed: Nov. 29, 2013
(86) PCT No.: PCT/IB2013/002665

§ 371 Date: Jun. 1, 2015

(30) Foreign Application Priority Data
Nov. 30, 2012 (IT) PD2012A000363

(51) Int. Cl. C02F 1/469

(52) U.S. Cl. CPC C02F 1/4695; C02F 2103/08

(57) ABSTRACT

Apparatus (1) for purifying a fluid, which comprises a first ion absorption cell (2), provided with a first chamber, through which a fluid to be treated flows containing cationic particles and anionic particles, and a second (9) and a third (15) chamber respectively containing a first electrode (13) positively charged and a second electrode (18) negatively charged by a first power supply source (14). The first chamber is separated from the second (9) and from the third (15) chamber respectively by means of a first septum (19) and a second septum (20) permeable to the anionic particles and cationic particles of the fluid the to be treated. Extraction means (100) are also provided for continuously removing the anionic particles and the cationic particles respectively absorbed by the first operative slurry and by the second operative slurry.

### FIELD OF APPLICATION

The present invention regards an apparatus for purifying a fluid and a method for purifying a fluid, in particular by means of the aforesaid apparatus, according to the preamble of the respective independent claims.

More in detail, the apparatus and the method according to the invention are intended to be advantageously employed for removing, from a fluid, ionized particles for the purpose of facilitating the recovery or disposal thereof. Such particles can typically be constituted by ions of salts dissolved in a liquid, or by metal ions e.g. of fluids of industrial processes.

The present apparatus can be intended for multiple applications in industrial as well as civil fields, such as the desalination of sea water, the softening of particularly hard waters, the removal of salts (such as chlorides and sulfates) from water, as well as the removal from any one liquid of nitrates, nitrites, ammonia, heavy metals, organic substances or micro-pollutants, or for the deionization of fluids e.g. for industrial processes or for the concentration of polluting substances that are difficult to dispose of or are advantageous to recover for a reuse.

The present invention is therefore generally inserted in the industrial field of the production of apparatuses for purifying fluids of ionized particles.

### STATE OF THE ART

Apparatuses are known for purifying fluids that exploit the principle of capacitive deionization for removing ionized particles from a fluid. Each cell is a set of flow-through capacitors and is formed by a plurality of superimposed electrodes, between which a flow of fluid to be purified is made to pass. The electrodes face each other and are charged with opposite polarities by a direct current power supply unit.

Operatively, such known apparatus provides for the alternation of operating steps, in which the ions present in the fluid are captured on the opposite electrodes, and regeneration steps, in which the ions accumulated on the electrodes are removed by means of a washing fluid.

The electrodes of the flow-through capacitors electrostatically absorb and release the ionic charge contaminants and actively participate in the process of deionization of the liquid to be treated.

The electrodes are also usually fed by collectors, for example made of graphite, and they are made of electrically conductive porous materials (e.g. typically made of carbon) in order to absorb high quantities of ionized particles on their surface.

Flow-through capacitors of the above-indicated known type are for example described in the patents U.S. Pat. No. 6,413,409 and U.S. Pat. No. 5,360,540.

The aforesaid operating and regeneration steps for the cells translate, with reference to the interaction between electrodes and ions, into the following operative steps:
a step for absorbing the ions on the porous surface of the carbon of the electrodes supplied with opposite voltages; the energy expended for such step is proportional to the quantity of ions that are captured;
a step of electrostatic liberation of the ions from the carbon of the electrodes, providing the latter with the previously absorbed quantity of charge, so as to neutralize the electrostatic attraction with the ions;
a step for moving away the ions that are no longer electrostatically bound, to outside the porous electrodes, by means of charge with reversed polarity of the ions, with the consequent possibility to remove them from the cell by means of the passage of the washing liquid.

The apparatuses with flow-through capacitors, present on the market and which exploit the principle of the capacitive deionization according to the cyclically repeated operative steps mentioned above, have proven in practice that they have numerous drawbacks.

Such drawbacks, as will be clarified hereinbelow, are the result of compromises for obtaining the above-indicated steps in a same volume of the cell and between the same electrodes which in the various steps must other react with the ions.

A first drawback lies in the fact that the cell has a greater volume than the containment volume of the electrodes, with a volume in the inlet zone that represents a queue after each cycle and which slows, in the case of multiple passages for reducing high salinity, the restarting of the subsequent operating step as well as negatively affects the efficiency of the cell. In addition, the alternation of the operating and regeneration steps leads to queues of diluted fluid that cannot be exploited and which contributes to negatively affecting the performances of the cell.

A second drawback lies in the fact that the carbon immobilized on the surface of the electrodes of the capacitors of the cells cannot be uniformly traversed by the fluid, which thus wears out one area of the electrode before others, with the consequence that the regeneration step takes place without all the carbon having been fully exploited for capturing the ions. Also such circumstance negatively affects the efficiency of the cell.

A third drawback lies in the need to discharge the washing liquid without being able to reach high salinity concentrations in the cell, so as to prevent the precipitation of salts and thus the fouling of the cell. A widespread problem in the cells with flow-through capacitors indeed pertains to the need to prevent the solutes from precipitating between the electrodes of the capacitor, obstructing the fluid passage channels and thus rendering the cell useless in the long term. As is known, during the regeneration step, the ions that are freed at the electrodes can be combined with each other in different forms, coming to modify the equilibrium of solubility of the salts, the pH of the fluid (in particular an increase of pH in the central pipe due to the initial formation of CO₂ from HCO₃⁻) or even the response to the action of the electric field of regeneration; these factors can lead to a precipitation of the salts, giving rise to crystals or encrustations.

It must also be considered that the capacity of the electrodes to capture the ions in solution, and more generally the charged particles, is a characteristic that positively affects the operation of the capacitor.

For such purpose, electrodes have been designed made of spongy active carbon, molded in the form of sheets or fibers, as described for example in the U.S. Pat. No. 6,413,409 or sheets of a mixture comprising PTFE as described for example in the U.S. Pat. No. 6,413,409.

Furthermore, in order to attempt to balance the need to capture and retain the ions during the operating step, but then easily release them during the regeneration step, the U.S. Pat. No. 6,709,560 has provided for the possibility to associate, with the surfaces of the electrodes, layers of permeable or semi-permeable material, in particular capable of selectively trapping the ions that migrate towards the corresponding electrode under the action of the field. Such layers are for example constituted by a selectively semi-permeable membrane of anion exchange type or of cation exchange type. The ions are thus retained or trapped in the layer of such material close to the electrode towards which they migrate, no longer being subjected to the vortical action of the fluid.

Otherwise, it is known to arrange paints on the electrodes that are capable of making positive or negative ions selectively pass.

None of these different embodiments of electrodes of the known apparatuses have proven entirely satisfactory, and in fact they represent the attempt to optimize the physical and electrical relation between the surface of the same electrodes and the ions to be treated upon variation of the above-described operative steps (absorption, liberation, moving away) without being able to optimize one step regardless of the subsequent actuation of another step.

A further important drawback that occurs in the manufacturing of the electrodes lies in the need to uniformly bring the current from the collector, generally made of graphite, to the porous electrode usually made of carbon and that is in contact with the fluid to be treated. Binders are usually used which in order to immobilize the carbon on the collector inevitably reduce the active surface thereof, worsening the performances thereof.

Further drawback intrinsic in the operating principle itself of the apparatuses with flow-through capacitors is the intermittence of operation that leads the cell to purify the fluid for a time that varies between 50 and 75% of its operation, and which follows from the need to subject the electrodes to the different abovementioned steps in order to operate in different times and modes on the ions (absorbing them, neutralizing them, moving them away).

### PRESENTATION OF THE INVENTION

In this situation, the problem underlying of the present invention is therefore to eliminate the problems of the abovementioned prior art, by providing an apparatus for purifying a fluid and a method for purifying a fluid, in particular by means of the aforesaid apparatus, which are capable of removing high quantities of ionized particles with a high capture efficiency.

Another object of the present invention is to provide an apparatus and a method for purifying a fluid, which are capable of purifying fluids contaminated by salts with any ionic force.

Another object of the present invention is to provide an apparatus and a method for purifying a fluid, which require a low consumption of washing liquid.

Another object of the present invention is to provide an apparatus and a method for purifying a fluid, which are capable of removing the ionized particles with high energy efficiency.

Another object of the present invention is to provide an apparatus for purifying a fluid that is simple and inexpensive to obtain and entirely reliable in operation.

Another object of the present invention is to provide an apparatus for purifying a fluid, which allows being employed in a versatile manner in different applications, for industrial processes as well as for the purification of water in civil field or for the desalination of sea water, given that it can be easily adapted to optimize its energy and capture performances.

### BRIEF DESCRIPTION OF THE DRAWINGS

The technical characteristics of the finding, according to the aforesaid objects, are clearly found in the contends of the below-reported claims and the advantages thereof will be more evident in the following detailed description, made with reference to the enclosed drawings, which represent several merely exemplifying and non-limiting embodiments thereof, in which:

FIG. 1 shows a general electrical and hydraulic operation scheme of the apparatus for purifying a fluid, according to the present invention;

FIG. 1A shows an electrical and hydraulic operation scheme of a first embodiment of an apparatus for purifying a fluid, according to the present invention;

FIG. 1B shows a second electrical and hydraulic operation scheme of a second embodiment of an apparatus for purifying a fluid, according to the present invention;

FIG. 1C shows a third electrical and hydraulic operation scheme of a third embodiment of an apparatus for purifying a fluid, according to the present invention;

FIG. 1D shows a fourth electrical and hydraulic operation scheme of a fourth embodiment of an apparatus for purifying a fluid, according to the present invention;

FIG. 1E shows a fifth electrical and hydraulic operating scheme of a fifth embodiment of an apparatus for purifying a fluid, according to the present invention;

FIG. 2 schematically shows a detail of the apparatus for purifying a fluid, object of the present invention, relative to a first cell for the absorption of ions;

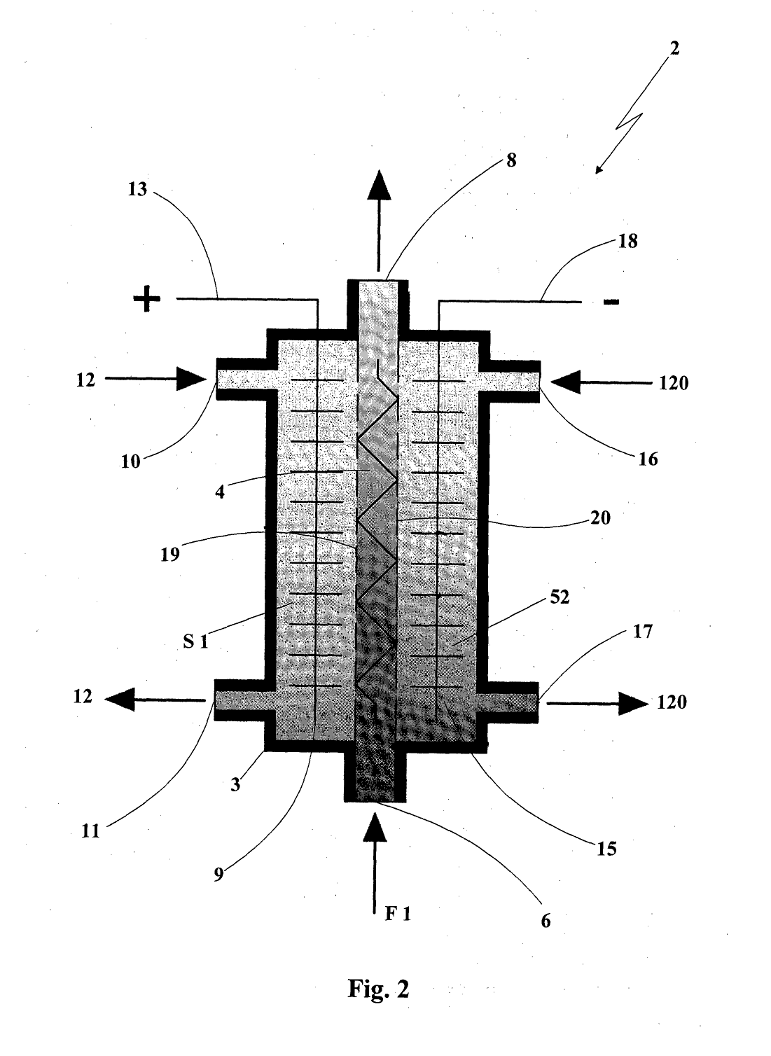

FIG. 3 schematically shows a detail of the apparatus for purifying a fluid, object of the present invention, relative to a second cell for the separation of ions;

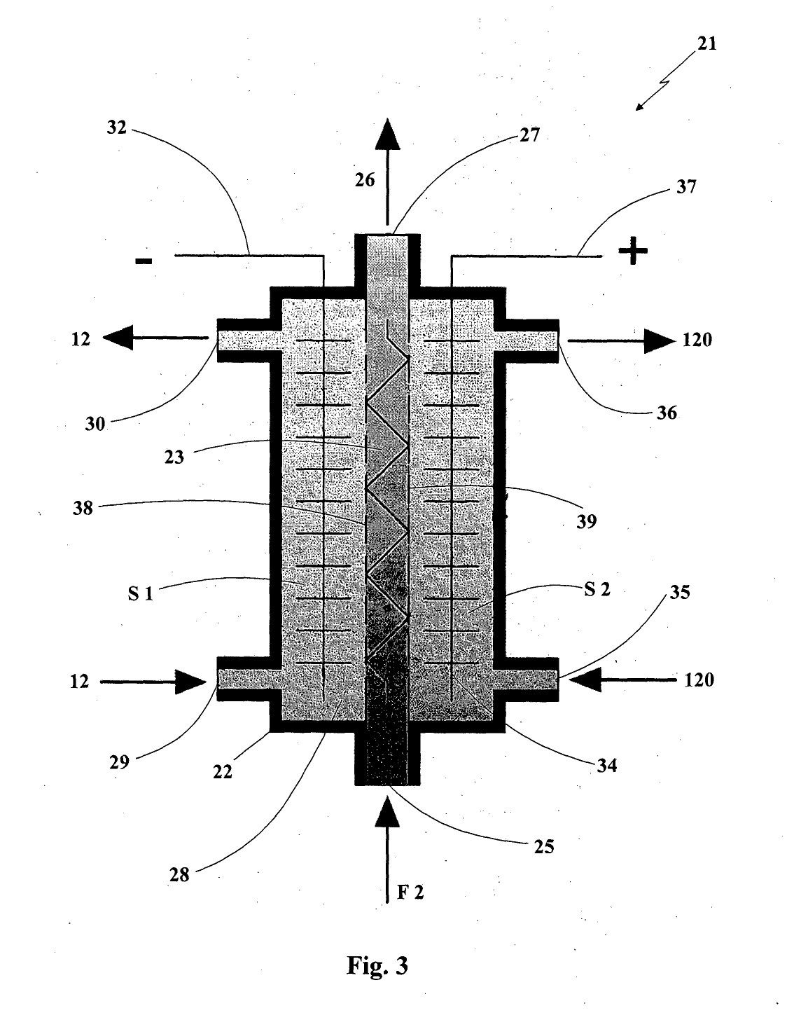

FIG. 4 schematically shows a detail of the apparatus for purifying a fluid, object of the present invention, relative to a third cell for the recovery of energy;

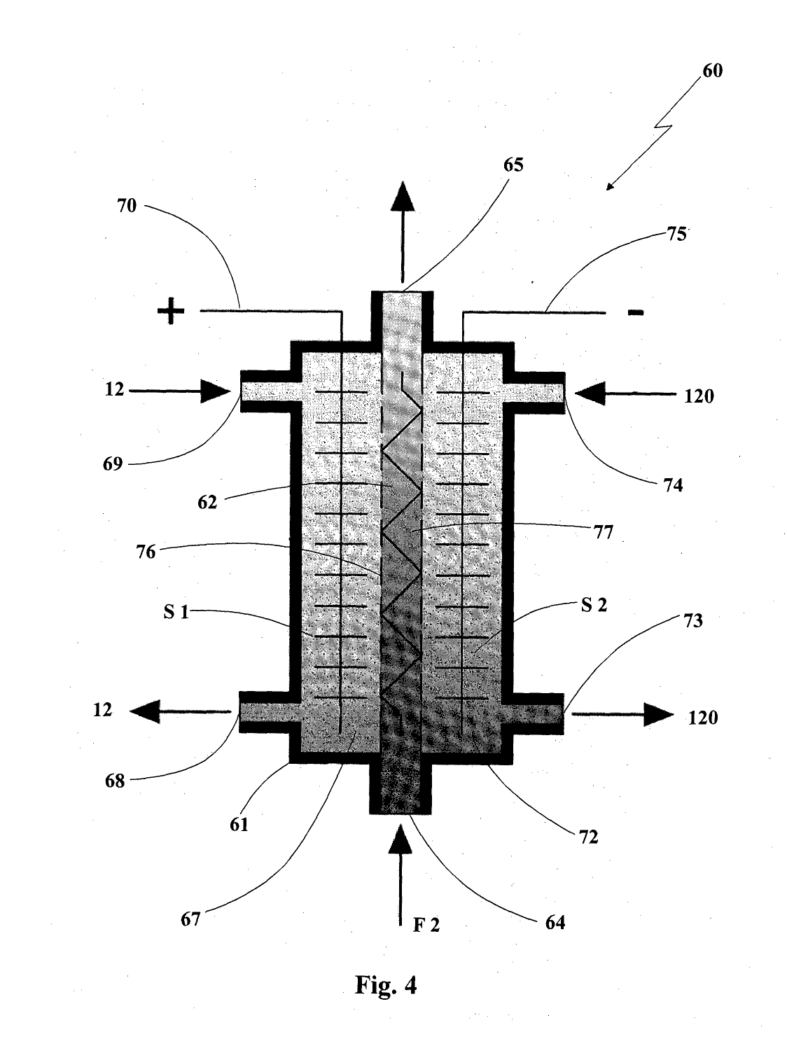

FIG. 5 schematically shows a detail of the apparatus for purifying a fluid, object of the present invention, relative to a tank for the balancing of the slurry;

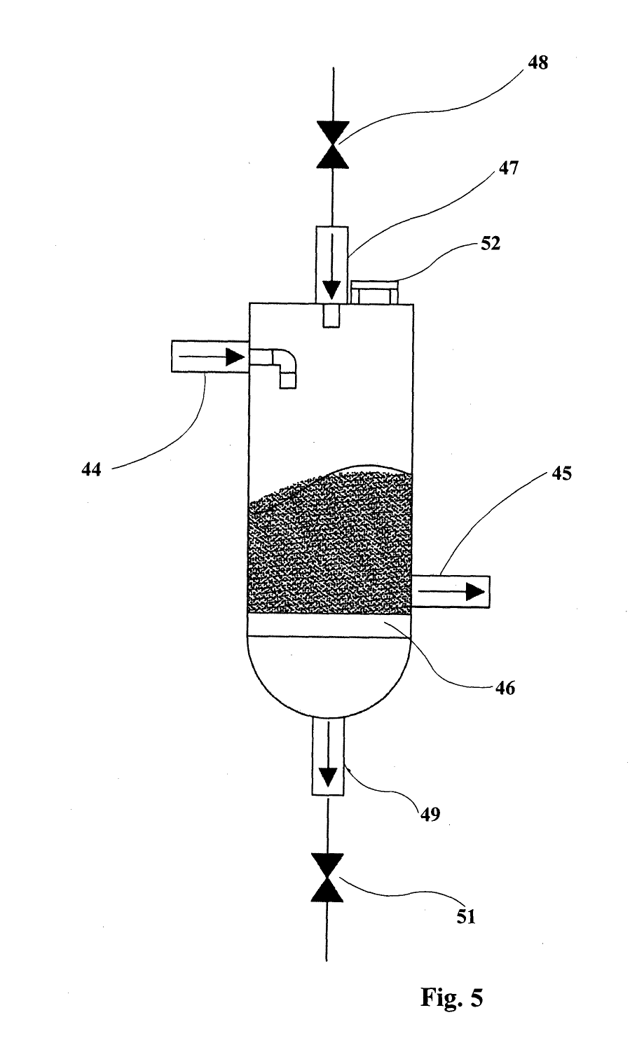

FIG. 6 shows an example of an electrical scheme for the connection in series of multiple first cells for the absorption of ions and third cells for the recovery of energy;

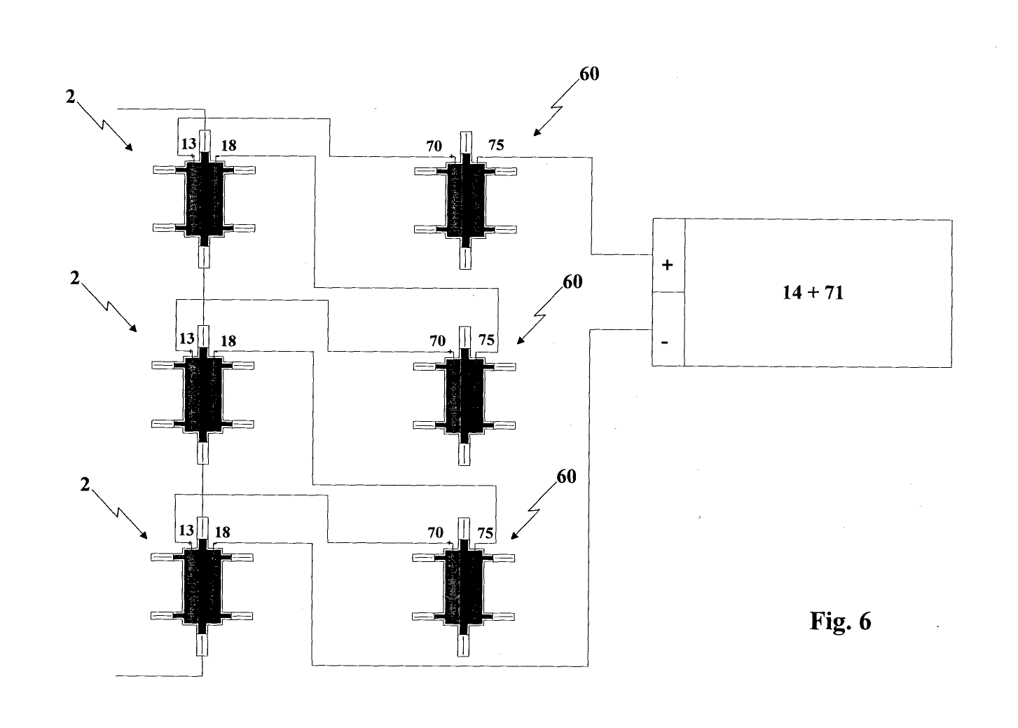

FIGS. 7A, 7B schematically show a detail of the apparatus for purifying a fluid, object of the present invention, relative to an embodiment of a first electrode for the first cell for the absorption of ions, in a plan view and in cross section;

FIGS. 8A, 8B schematically show a detail of the apparatus for purifying a fluid, object of the present invention, relative to an embodiment of a second electrode for the first cell for the absorption of ions, in a plan view and in cross section;

FIGS. 9A, 9B schematically shows a detail of the apparatus for purifying a fluid, object of the present invention, relative to an embodiment of insulating spacer septum for the first cell for the absorption of ions, in a plan view and in cross section;

FIG. 10 schematically shows a detail of the apparatus for purifying a fluid, object of the present invention, relative to an embodiment of separator septum for the first cell for the absorption of ions;

FIG. 11 shows a longitudinal view of the section of the first cell for the absorption of ions carried out along the supply passage of the two slurries that feed the first cell;

FIG. 12 shows a longitudinal view of the section of the first cell for the absorption of ions carried out along the supply passages of the fluid to be purified that feed the first cell.

### DETAILED DESCRIPTION OF A PREFERRED EMBODIMENT

With reference to the set of drawings, reference number 1 indicates overall an embodiment of an apparatus for purifying a fluid, object of the present invention.

The apparatus 1, according to the invention, is adapted to be employed for purifying fluids of ionized particles present therein that are susceptible to be affected by the presence of an electric field, such as ions in solutions.

Hereinbelow, the term ionized particles generically indicates any contaminant dissolved in the fluid to be treated that is capable of being attracted by an electrostatic field, such as in particular the ions dissolved in a fluid.

The apparatus 1 is therefore adapted to operate for the deionization of fluids of industrial processes and for the deionization of water, in particular for softening the water of the water supply system and for the desalination of sea water; it is particularly capable of removing, from its interior, salts in solution (such as chlorides and sulfates), nitrates, nitrites, ammonia, and other polarized contaminants of organic substances or micro-pollutants in general.

The apparatus 1 is also adapted to concentrate within fluids, particularly of industrial processes, ionized particles for facilitating the recovery or the disposal thereof.

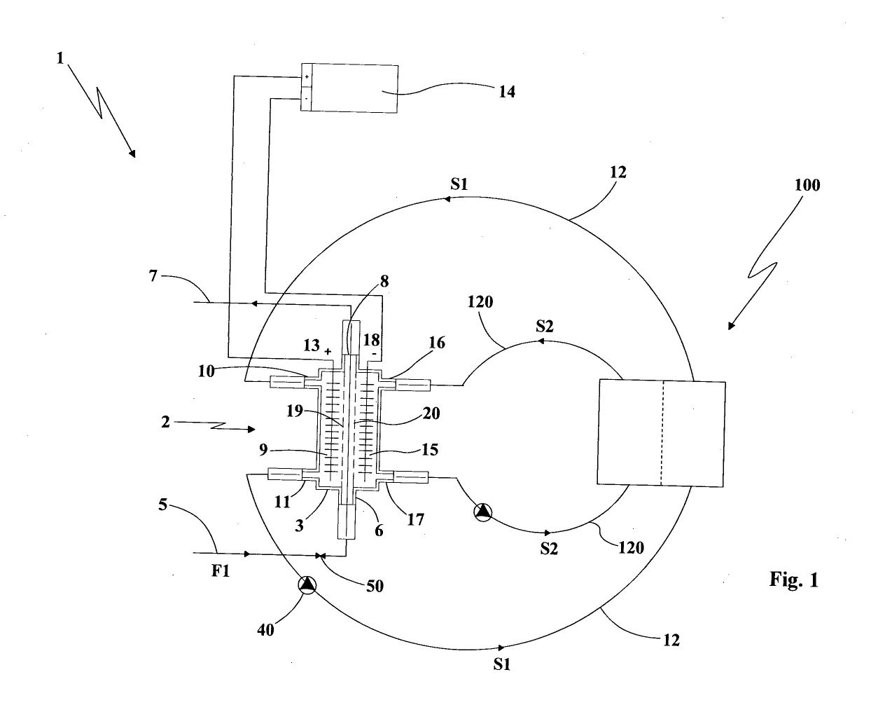

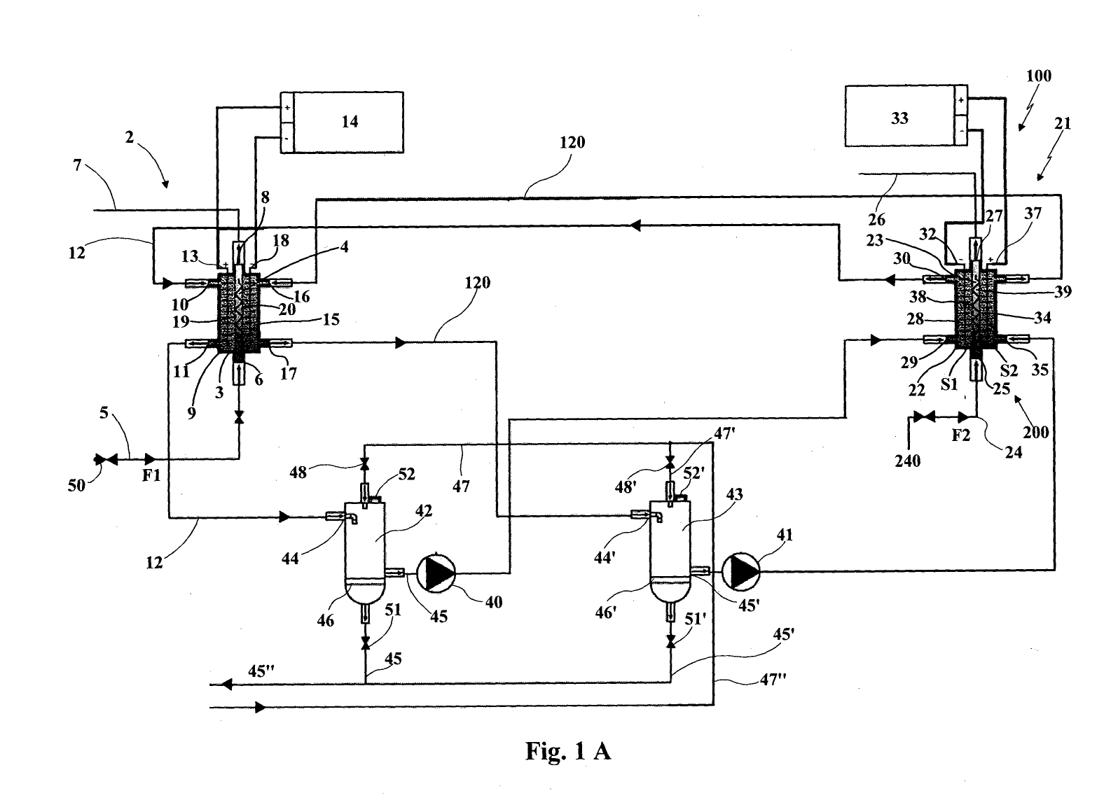

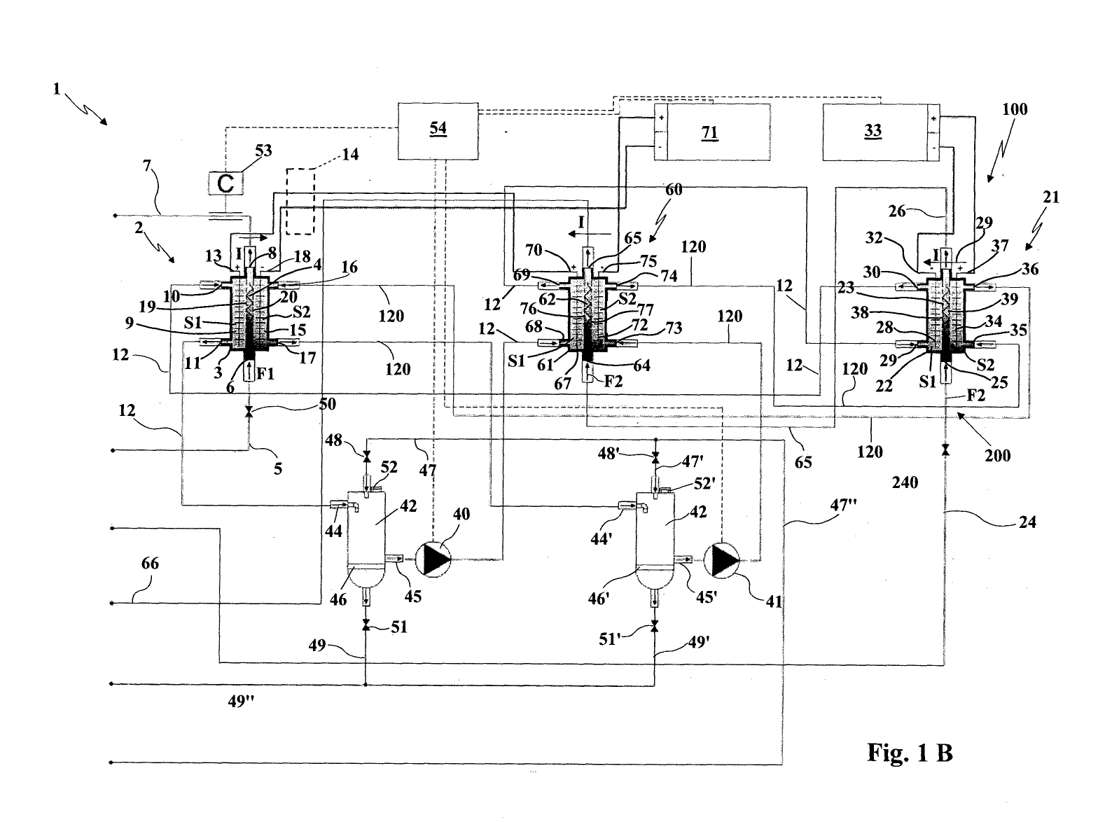

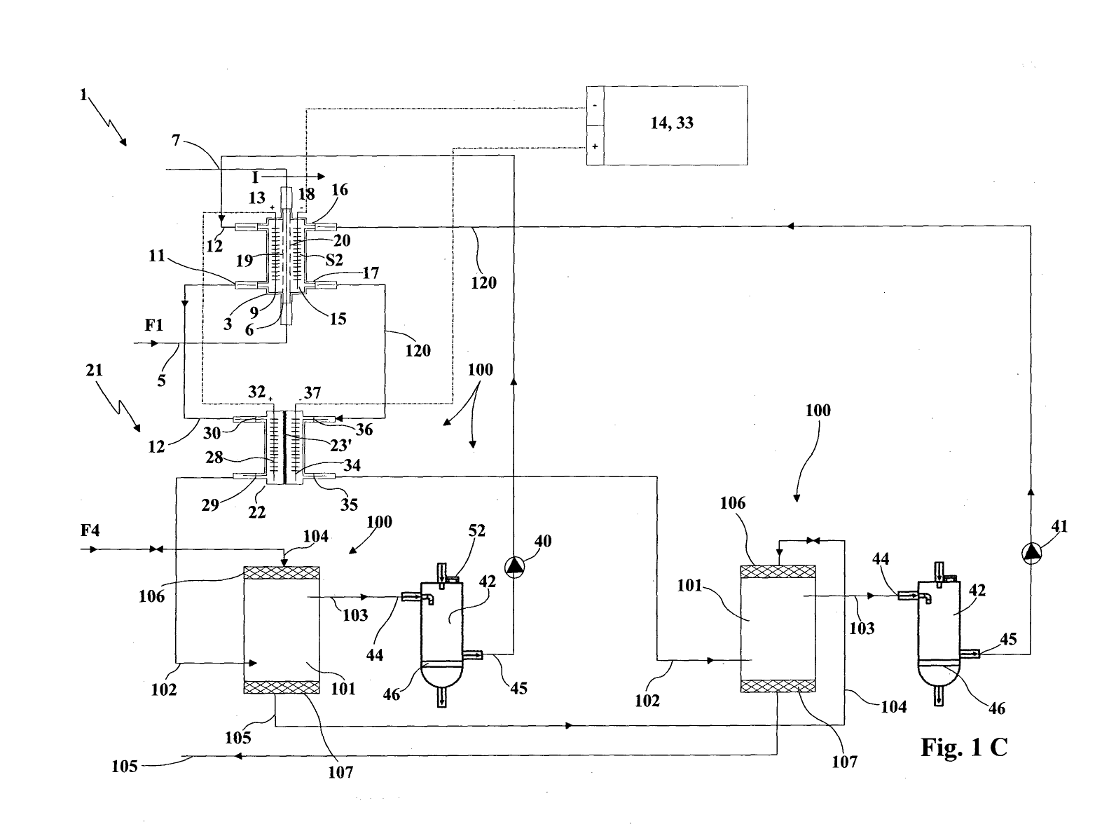

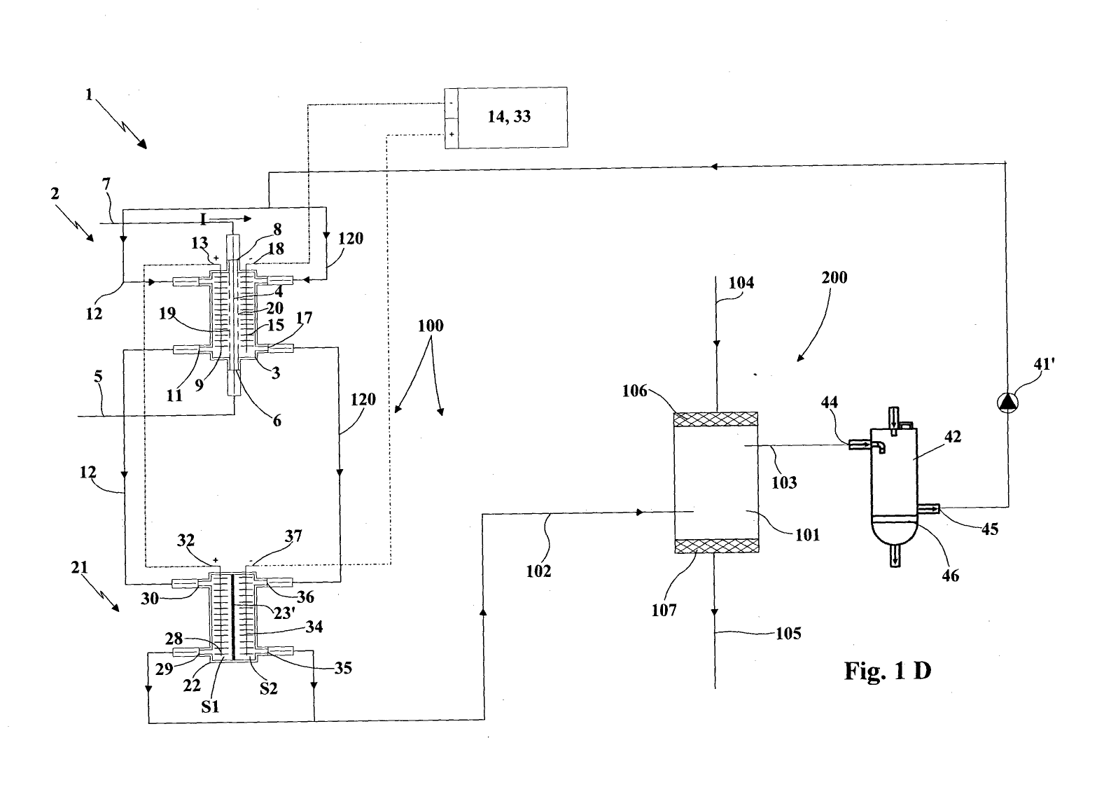

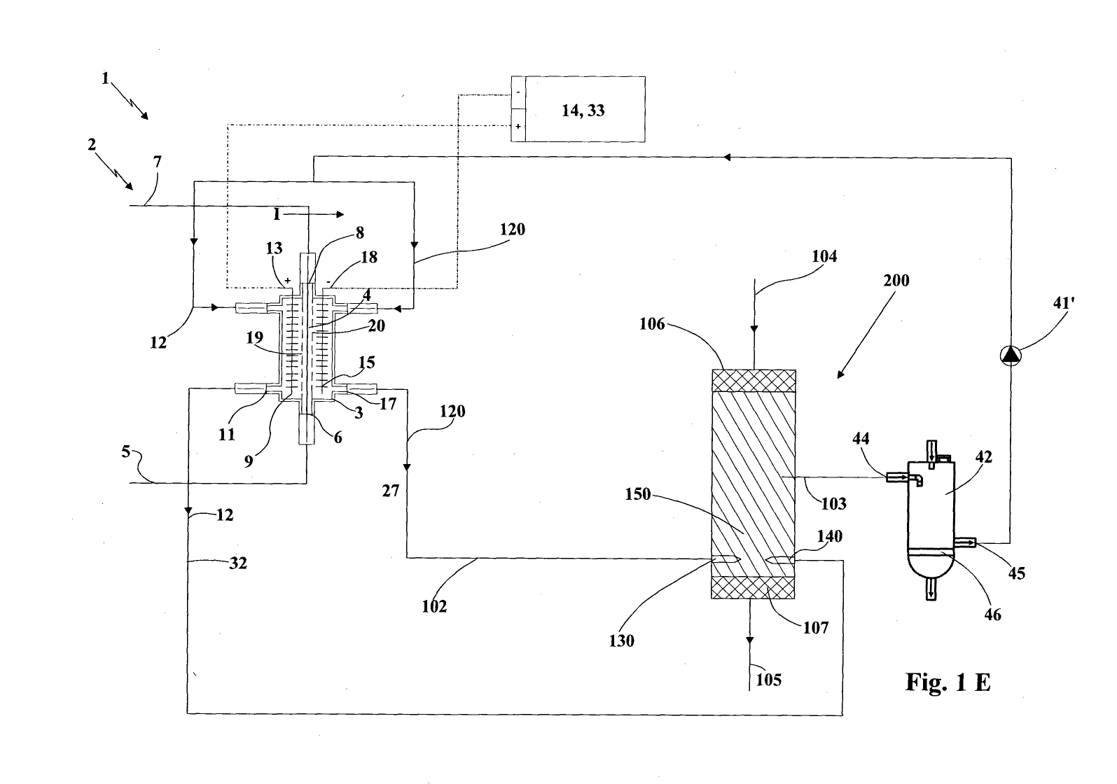

In accordance with the present invention and with the scheme of the general FIG. 1, the apparatus 1 comprises a first ion absorption cell 2, provided with a first containment structure 3, e.g. made of plastic material, which contains therein at least the three chambers specified hereinbelow.

A first chamber 4 of the first cell 2 is traversed by a flow of fluid to be treated F1 containing cationic particles and anionic particles, which can represent pollutants to be removed (such as the salt of an apparatus intended for the desalination of sea water) or substances to be recovered (such as metals of a galvanic bath of an industrial process). Such fluid F1 can therefore be an aqueous solution, or also a solution in which charged particles are found dissolved in a non-water based solvent. Such first chamber 4 is for such purpose fed with the fluid to be treated F1 by means of a first supply pipe 5, connected thereto through a first inlet opening 6 and it in turn transfers the treated fluid to the outside by means of a first delivery pipe 7 connected to the first chamber 4 by means of a first outlet opening 8. Advantageously, the aforesaid first supply pipe 5 is intercepted by a valve 50 for adjusting the flow of the liquid to be treated F1, which can also be controlled in a chokable manner by a logic control unit indicated hereinbelow.

A second chamber 9 of the first cell. 2 is traversed by a first operative slurry S1 containing first corpuscles susceptible to be electrostatically charged, given that for such purpose it is provided with a second inlet opening 10 and a second outlet opening 11 connected to a first circuit 12 in which such first operative slurry S1 circulates.

Inside such second chamber 9, a first electrode 13 is housed, which is positively charged by a first power supply source 14.

A third chamber 15 is traversed by a second operative slurry S2 containing second corpuscles susceptible to be electrostatically charged, given that for such purpose it is provided with a third inlet opening 16 and a third outlet opening 17 connected to a second circuit 120 in which such second operative slurry S2 circulates.

In the first and in the second circuit 12, 120 and hence inside the second and third chamber 9, 15 respectively intercepted by such circuits, the two slurries S1, S2 continuously circulate. For such purpose, they are respectively intercepted by the first and second circulation means, respectively constituted by a first recirculation pump 40 and a second recirculation pump 41.

Inside such third chamber 15, a second electrode 18 is housed which is negatively charged by the first power supply source 14.

The first power supply source 14 is capable of supplying to the electrodes 13 and 17 the aforesaid positive and negative voltages, with direct power supply or with pulsed power supply having average value of the voltage respectively positive and negative. The value of the voltage will depend on the specific application and on the size of the plant where the cell 2 is intended to work. In case of desalination of the water supply for a domestic installation, a voltage value of a few volts could for example be provided.

Inside the first containment structure 3 of the first cell 2, the second and the third chamber 9, 15 are hydraulically separated from each other with the interposition of the first chamber 4.

More in detail, the second and the third chamber 9, 15 are separated from the first chamber 4 respectively by means of a first septum 19 and a second septum 20, interposed at at least partial containment of the fluid to be treated F1 that circulates in the first chamber 4 with respect to the slurries S1 and S2 that circulate in the second and third chamber 9, 15. Such first and second septum 19, 20 are respectively permeable to at least the anionic particles and to at least the cationic particles, which as explained hereinbelow are forced by the action of the electric field produced by the first power supply source 14 to pass from the fluid to be treated F1 into the first slurry S1 and into the second slurry S2. They must instead retain the first and the second corpuscles in the respective first and second slurry S1 and S2 as well as strongly limit, preferably entirely prevent, the passage of the fluids F1, S1 and S2 through them. Depending on the application provided and on the type of septa employed, a small dilution of one fluid by a contiguous one can be tolerated. It can also be provided to calibrate the circulation pressures of the fluids F1, S1 and S2 in the three chambers 4, 9 and 15 in order to prevent or limit such dilutions.

Advantageously, the abovementioned septa 19 and 20 can be selected from among: ion exchange membranes (cationic or anionic) with different functional groups; insulating porous separators or conductors such as TNT (non-woven fabric) glass fiber structures; microporous membranes such as micro/ultra/nanofiltration membranes; microporous separators with conductive polymers.

Advantageously the slurries S1, S2 can themselves contain first and second corpuscles susceptible to be electrostatically charged in contact with the electrodes and can be constituted by carbon powders with high porosity or by corpuscles well-known to be used in the manufacturing of flow batteries, such as SiO2, TiO2, metal oxides, grapheme, carbon nanotubes, carbon fibers, carbon nanofibers possibly produced by electro-spinning and other substances commonly known for the transport and accumulation of electrostatic charges.

They are therefore contained, for example, in a percentage by weight comprised between 10% and 50% of the overall slurry flow, typically provided with water as fluid vector for the movement of the corpuscles.

The aforesaid power supply source 14 generates a first electric current running from the first positive electrode 13 associated with the first slurry S1 which absorbed the anionic particles to the second negative electrode 18 associated with the second slurry S2 which absorbed said cationic particles.

According to the idea underlying the present invention, extraction means 100 are provided for continuously removing the anionic particles and the cationic particles respectively absorbed by the first operative slurry S1 and by the second operative slurry S2.

The extraction means 100 determine the regeneration of the first and the second slurry S1, S2 by removing the anionic particles and cationic particles therefrom that were respectively absorbed in the second chamber 9 and in the third chamber 15 of the first cell 2. The two slurry flows S1, S2, once regenerated by the extraction means 100, are conveyed from the respective first and second circuit 12, 120 respectively to the second inlet opening 10 of the second chamber 9 and to the third inlet opening 16 of the third chamber 15 of the first cell 2, in order to allow the latter to have a continuous operation.

The extraction means 100 for the anionic particles and cationic particles can be associated with the two slurries by providing for common, undifferentiated components for the two slurries. Or, as schematized by the dashed line of FIG. 1, they can comprise components dedicated for the selective extraction from the specific slurry of the anionic particles or the cationic particles as will be clarified more in detail below, for example providing for specific washing means for the two slurries, or specific chambers for the selective electrostatic separation of the anionic particles and cationic particles from the corpuscles of the relative slurry.

The aforesaid extraction means 100 will in any case operate on a slurry, which they continuously pick up and feed to the first cell 1 for an operation of the apparatus that allows obtaining, at the outlet of the first chamber, the treated liquid without anionic particles and cationic particles (or at least with a smaller quantity thereof).

For such purpose, as described in detail hereinbelow with reference to the various possible non-limiting embodiments of the present invention, the aforesaid extraction means 100 can be obtained by means of washing means of the slurries in suitable tanks common to the slurries, or by means of washing means in which the anionic particles and cationic particles flow which have been separated from the corpuscles of the slurries in contact with corresponding electrodes, or by means of the combined action of electric fields produced by electrodes traversed by the slurries in respective chambers for the separation of the charged particles and washing means in chambers contiguous to those containing the electrodes, in accordance with the non-limiting embodiments illustrated below.

The extraction of the anionic particles and cationic particles from the respective slurry S1, S2 by means of the aforesaid extraction means 100 operatively provides for the electrostatic discharge of the corpuscles of the slurries, in order to break the electrostatic bond that binds them to the anionic particles and cationic particles, and then the subsequent moving away of the charged particles from the corpuscles which must recirculate in the respective circuits 12, 120. Such moving away can for example occur due to the washing of the two slurries in tanks (together or in a separate manner) or due to the action of electric fields with the traversing of only the charged particles separated through membranes (advantageously anionic and cationic) in order to reach chambers traversed by washing fluids.

The aforesaid extraction means 100 must therefore be intended as including the means capable of determining the separation of the anionic particles and cationic particles from the first and from the second corpuscles (by means of simple non-power supplied electrodes or by means of power-supplied electrodes in order to also force the moving away of the particles from the corpuscles) as well as the washing means 200 for moving away the particles in accordance with the different embodiments illustrated below.

In accordance with the embodiments of the present invention, illustrated in the FIGS. 1A, 1B, 1C and 1D, the apparatus 1 structurally also comprises at least one second ion separation cell 21 provided with a second containment structure 22, e.g. it too like the first made of plastic material, which contains therein the further chambers specified hereinbelow.

The first and the second containment structure 3, 22 of the two cells 2, 21 can be advantageously in common even if maintaining physically separated the respective chambers for the passage of the relative fluids.

A fourth chamber 28 of the second cell 21 is traversed by the first operative slurry S1, and is for such purpose provided with a fourth inlet opening 29 and a fourth outlet opening 30 connected to the first circuit 12 in which such first operative slurry S1 circulates.

A fifth chamber 34 is traversed by the second operative slurry S2, and is for such purpose provided with a fifth inlet opening 35 and a fifth outlet opening 36 connected to the second circuit 120 in which such second operative slurry S2 circulates.

Inside the fourth chamber 28 and the fifth chamber 34, a third electrode 32 and a fourth electrode 37 are respectively housed.

Also provided for is at least one conductive separator 23, 23′, which as explained below can be constituted by a sixth chamber 23 of the second cell 21 traversed by a conductive fluid (in accordance with the embodiments of the figures A, B) or by a conductive diaphragm 23′ (in accordance with the embodiments of the figures C, D), interposed between the aforesaid fourth 28 and fifth 34 chamber.

In accordance with all the abovementioned embodiments of the figures A, B, C and D, operatively the third electrode 32 and the fourth electrode 37 electrostatically separate the first and the second corpuscles respectively from the anionic particles and from the cationic particles at the passage on the electrodes respectively of the first and the second slurry S, S2. Following such passage, a second electric current is generated with the conductive separator 23, 23′, running in the slurries of such second cell 21 opposite the first current between the slurries contained in the first cell 2. More in detail, in the first cell 2 the flow of current ran from the first electrode 13 associated with the first slurry S1 intended to absorb the negative ions to the second electrode 18 associated with the second slurry intended to absorb the positive ions, while in the second cell 21 such current runs from the fourth electrode 37 associated with the second slurry S2 to the third electrode 32 associated with the first slurry S1.

If the electrodes 32, 37 are power supplied (as in the embodiment of FIGS. 1A and 1B), such second cell 21 will function as a user and the current will depart from the positive pole 37 in order to enter the negative pole 32, while if such second cell 21 is not power supplied (as in the embodiment of FIGS. 1C and 1D) and acts as a generator, then the current will naturally depart from the negative pole 32 and enter the positive pole 37.

As will be clarified below, it is specified that in the case of the embodiment of FIG. 1B, the particles are only moved away from the power-supplied electrodes 32, 37 of the second cell 21, since the separation of the particles occurs beforehand in a further third cell 60 described in detail below.

In each case, the conductive separator 23, 23′ will act as a conductor element for closing the electric circuit between the two electrodes 32, 37.

The separation of the anionic particles and cationic particles from the corpuscles of the slurries allows recovering energy only if it is achieved in a manner separate from the moving away of the same particles from the corpuscles; this whether such moving away is obtained due to the action of an electric field (FIG. 1A) or such moving away is obtained due to a mechanical action (FIG. 1E). The embodiments illustrated in the examples of FIGS. 1B, 1C and 1D, by dividing the operation of separation (discharge of the corpuscles) and moving away of the charged particles allow recovering most of the energy supplied for the electrostatic absorption of the same charged particles in the first cell 2 by the corpuscles.

In accordance with the embodiment of FIG. 1A, the separation and the moving away of the anionic particles and cationic particles from the corpuscles of the respective first and second slurry S1, S2 occurs at the same time in the second cell 21 in a forced manner, through the application of an electric field between the two electrodes 32, 37. Such field first determines the neutralization of the charge of the corpuscles with electrostatic separation of the charged particles therefrom, and then the subsequent moving away of the same charged particles from the corpuscles; such charged particles, attracted in moving away by the electrode with opposite charge, traverse the respective anionic and cationic membranes in order to reach a chamber where they are taken away by a washing fluid.

More in detail, in accordance with the embodiment illustrated in FIG. 1A, the third and the fourth electrode 32, 37 are respectively negatively and positively power supplied by a second power supply source 33.

A sixth chamber 23 of the second cell 21 is traversed by a flow of washing fluid F2 and is for such purpose fed by means of a second supply pipe 24 with the washing fluid F2, connected thereto through a sixth inlet opening 25, and it transfers the treated fluid to the outside by means of a second delivery pipe 26 in turn connected to the sixth chamber 23 by means of a sixth outlet opening 27. Advantageously, the aforesaid second supply pipe 24 is intercepted by a second valve 240 for adjusting the flow of washing liquid F2, which can also be controlled in a chokable manner by a logic control unit indicated below or with a discontinuous pulsed intervention.

The second power supply source 33 will be capable of supplying the electrodes 32 and 36 with the aforesaid negative and positive voltages, with direct power supply or with pulsed power supply having average voltage value respectively positive and negative. The two power supply sources 14 and 33 can be shared or separate and possibly electrically connected to each other.

Inside the second containment structure 22 of the second cell 21, the fourth and the fifth chamber 28, 34 are hydraulically separated from each other with the interposition of the sixth chamber 23. More in detail, the fourth and the fifth chamber 28, 34 are separated from the sixth chamber 23 respectively by means of a third septum 38 and a fourth septum 39, interposed at at least partial containment of the washing fluid F2 that circulates in the sixth chamber 23 with respect to the slurries S1 and S2 that circulate in the fourth and fifth chambers 28, 34. Such third and fourth septum 38, 39 are respectively permeable to at least the anionic particles and to at least the cationic particles, which as explained hereinbelow are forced by the action of the electric field produced by the second power supply source 33 to pass from the first and from the second slurry S1, S2 to the washing fluid F2.

Such septa must instead retain the first and the second corpuscles in the respective first and second slurry S1 and S2 as well as strongly limit, and preferably entirely prevent the passage of the fluids F2, S1 and S2 through them. Depending on the application provided and on the type of septa employed, a small dilution of one fluid by a contiguous one can be tolerated. It can also be provided to calibrate the pressures of circulation of the fluids F2, S1 and S2 in the three chambers 23, 28 and 34 in order to prevent or limit such dilutions.

Advantageously, the third and the fourth septum 38, 39 are selective ions for example constituted by ion exchange membranes (respectively anionic and cationic) in order to prevent the anionic particles and cationic particles which have reached the washing liquid F2 through respectively the third and the fourth septum 38, 39, respectively coming from the first slurry S1 and from the second slurry S2, from passing over, attracted by the electric field, and respectively entering into the second slurry S2 and into the first slurry S1, traversing respectively the fourth septum. 39 and the third septum 38 in the direction opposite that desired.

In accordance with the structural configuration described above and in connection with the scheme of FIG. 1, the first circuit 12 therefore connects the second outlet opening 11 of the second chamber 9 of the first cell 2 to the fourth inlet opening 29 of the fourth chamber 28 of the second cell 21, and the fourth outlet opening 30 of the fourth chamber 28 of the second cell 21 to the second inlet opening 10 of the second chamber 9 of the first cell 2; while the second circuit 120 connects the third outlet opening 17 of the third chamber 15 of the first cell 2 to the fifth inlet opening 35 of the fifth chamber 34 of the second cell 21, and the fifth outlet opening 36 of the fifth chamber 34 of the second cell 21 to the third inlet opening 16 of the third chamber 15 of the first cell 2.

Operatively, according to the present invention, the first corpuscles contained in the first slurry S1 which traverse the first circuit 12 are electrostatically charged in contact with the first positive electrode 13 of the second chamber 9 of the first cell 2, absorbing anionic particles from the fluid F1 to be treated, and release the anionic particles to the washing fluid F2 under the action of the electric field produced by the electrodes 32 and 37.

Therefore, first the first corpuscles are discharged in contact with the third negative electrode 32 of the fifth chamber 28 of the second cell 21 and then the anionic particles migrate towards the fourth positive electrode 37, remaining trapped in the sixth chamber 23.

Analogously, the second corpuscles contained in the second slurry S2, which traverses the second circuit 120, are electrostatically charged in contact with the second negative electrode 18 in the third chamber 15 of the first cell 2, absorbing cationic particles from the fluid F1 to be treated and they release the cationic particles to the washing fluid F2.

Hence, also in this case, first the second corpuscles are discharged in contact with the fourth positive electrode 37 of the fifth chamber 34 of the second cell 21 and then the cationic particles migrate towards the third negative electrode 32, remaining trapped in the sixth chamber 23.

Before releasing and moving away the anionic particles and cationic particles under the action of the field produced by the third and fourth electrode, the corpuscles of the first and the second slurry S1 and S2 must be electrostatically discharged, an operation that can be achieved both in the aforesaid second cell 21 by the second power supply source 33 though preferably, as indicated below with reference to the embodiment of FIG. 1B, in a third cell 60 with current generation and partial substantial energy recovery.

Once the anionic particles and cationic particles have been electrostatically separated from the first and from the second corpuscles of the first and the second slurry S1, S2, it will be possible to easily remove them by means of the washing means 200 represented in this example by the sixth chamber 23 separated from the fourth and fifth chamber 28, 34 by the septa 38 and 39 and traversed by the washing fluid F2.

Such washing fluid F2 can be an aqueous solution, or a solution containing a solubilizing product susceptible to increase the solubility of the specific ionized particles with which it is intended to interact in the provided application, by increasing the precipitation threshold thereof. Such fluid can therefore be constituted by a solution containing a counter-ion capable of inhibiting, within certain limits, the precipitation of the ions of the ionized particles coming from the two slurries S1, S2, as explained hereinbelow; thus, for example, it can be constituted by an acidic solution for the solubilization of carbonates or bicarbonates.

The washing fluid F2 is an at least partially conductive fluid, preferably highly conductive, in order to allow the closure of the electric circuit between the third negative electrode 32 and the fourth positive electrode 37 inside the second cell 21.

The first circuit 12 and the second circuit 120 in which the first and the second slurry S1 and S2 circulate are respectively intercepted by first and second circulation means, mentioned above as advantageously constituted, respectively, by a first recirculation pump 40 and a second recirculation pump 41.

In accordance with the preferred embodiment illustrated in the enclosed figures, the aforesaid first and second slurry S1 and S2 are also intercepted respectively by a first and a second slurry compensator tank 42 by means of first and second inlet and outlet connections respectively 44, 45 and 44′, 45′.

In the simplest operation thereof, each of the two slurry compensator tanks 42 has the purpose of creating a storage and control tank for the slurries S1, S2 as well as to supply the pumps 40, 41 with a sufficient head for the correct suction. Another function of the volume compensator is therefore to adjust the operating pressure of the relative circuit of the slurry.

Another object of the two slurry compensator tanks 42 is to remove the particles which have been degraded due to friction, possible mud or other undesired substances that have accumulated in the circuits 12, 120 over time.

For such purpose, each of the aforesaid slurry compensator tanks 42 is also advantageously provided with at least one first porous filtering septum 46, 46′ susceptible to retain respectively the first corpuscles and the second corpuscles of the two slurries S1 and S2 of greater size than a predetermined value.

The size and shape characteristics of the corpuscles must ensure an optimal absorption of the charged particles and, for such purpose, the mesh of the first porous filtering septum 46 is calibrated in order to ensure that the dimensions of the corpuscles circulating in the circuits 12 and 120 do not descend below a threshold value.

The aforesaid first and second tank 42 are also each preferably connected to a first supply piping 47, 47′ of a washing liquid F3 (having for example an initial part 47″ in common) by means of a respective third valve 48, 48′, and to a first discharge piping 49, 49′ (having for example a terminal part 49″ in common) by means of a fourth valve 51, 51′, for subjecting the corresponding slurry contained in the two tanks 42 to a forced washing action.

Each of the aforesaid slurry compensator tanks 42 also has the function of allowing the control of the total volume of slurry in recirculation and facilitating the adjustment of its level.

Advantageously, for such purpose, each of the aforesaid slurry compensator tanks 42 is provided with an opening 52, 52′ for the insertion respectively of the first or second corpuscles of slurry (on their own or in a slurry solution).

The above-described apparatus 1 from the structural standpoint is particularly adapted for the continuous removal, from a fluid to be treated F1, of the cationic particles and anionic particles dissolved therein.

Advantageously, the two cells 2 and 21 can be sized and optimized for each to carry out its specific functionality; i.e., in the first cell 2, absorption of the cationic particles and anionic particles from the fluid to be treated F1 by the two slurry flows, and in the second cell 21 (physically separate now from the first cell with respect to the common flow-through capacitors—even if possibly inserted in a common casing), transfer to a washing liquid of the same particles previously captured by the two slurries with opposite polarities.

Such continuous operation is suitable for attaining numerous advantages.

For example, the apparatus 1 can advantageously comprise a conductivity meter 53 placed to intercept the first delivery pipe 7, exiting from the first chamber 4 of the first cell 2, in order to detect the conductivity of the treated fluid F1 and hence verify the efficiency of the treatment sustained by the fluid F1, i.e. the reaching or not reaching of a preset conductivity value and hence the desired purification level.

For such purpose, a logic control unit 54 is also provided, which is in communication with the first and second circulation means 40, 41 of the two slurries S1 and S2 in the two circuits 12 and 120. Such logic control unit 54 is susceptible to compare the conductivity value presettable therein, with greater or smaller value detected by the conductivity meter 53, so as to consequently control a corresponding increase or decrease of the circulation speed of the first and the second slurry S1, S2 by means of the control of the first and second circulation means 40, 41.

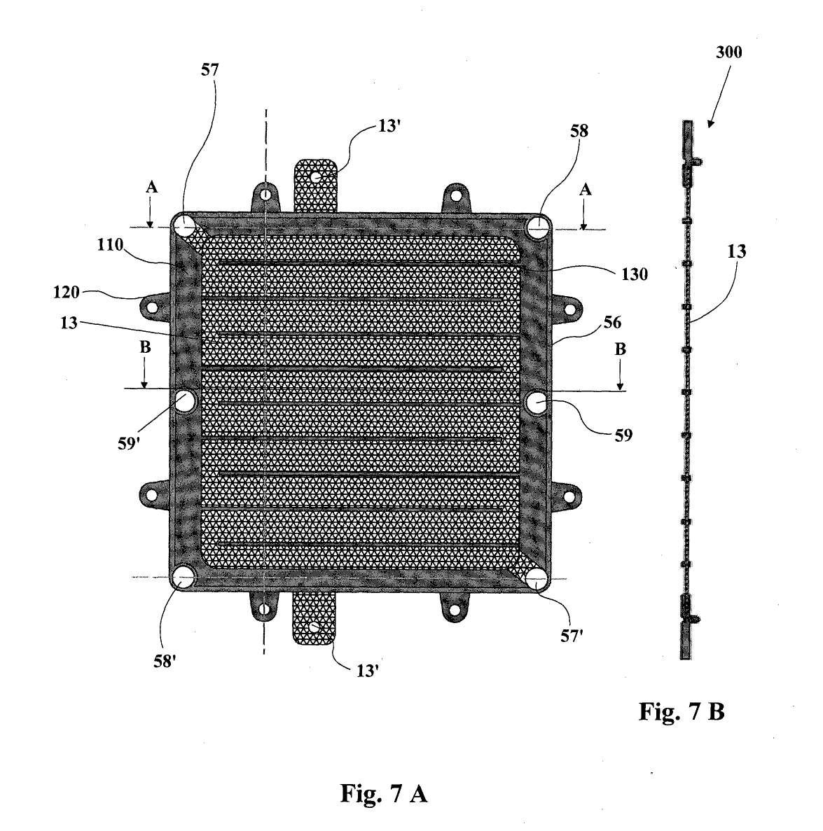

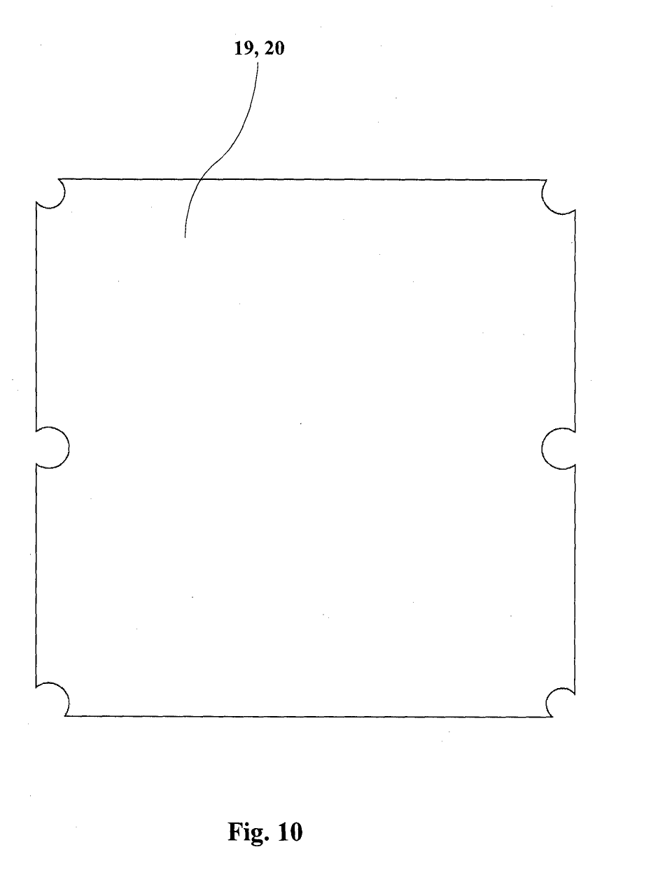

In accordance with a possible and advantageous embodiment of the present invention, illustrated in the enclosed FIGS. 7-12, the first cell 2 is obtained in the form of parallel plate exchanger with three feed fluids and thus it is provided with 6 pipes, including one inlet pipe and one outlet pipe for each fluid.

Advantageously, the first and the second electrodes 13, 18 of the first cell 2 are each obtained by means of a plurality of first and second conductive plate-like elements, in particular with metal net form, e.g. made of steel, placed in succession inside the casing 3 of the first cell 2 with alternated polarity.

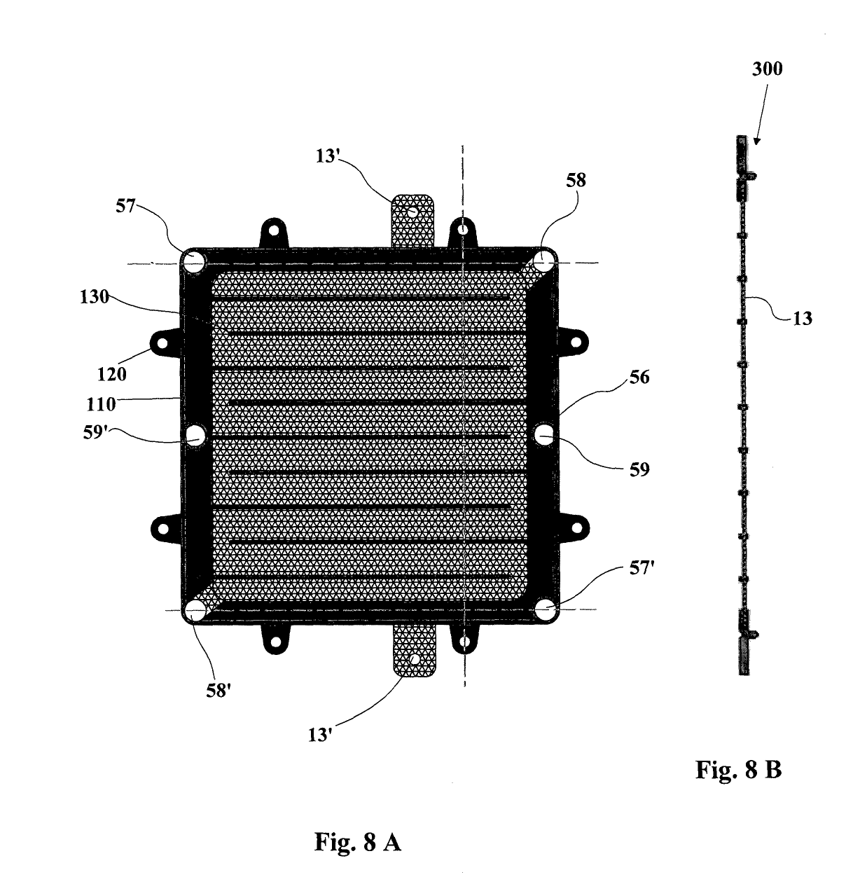

Each of the aforesaid first and second conductive plate-like elements 13, 18 is spaced on both faces by two corresponding first or second septa 19, 20 in order to form sub-chambers therewith, i.e. volumetric portions of the respective second and third chamber 9, 15 for the passage of the slurries S1, S2. Advantageously, the slurries are optionally forced to pass into fixed paths (see FIGS. 7 and 8) defined by specific patterns, e.g. in serpentine form created by spacers 130 which rise from the conductive elements 13, 18 before being able to leave the aforesaid sub-chambers.

The sub-chambers thus formed containing the first or the second conductive plate-like elements 13, 18 are alternately arranged in succession in a stack, interposing between the first and the second contiguous septa 19, 20 for separating electrodes with opposite polarity, respectively positive and negative, insulating spacer septa 55 in turn adapted to define together with the aforesaid pairs of first and second contiguous septa 19, 20 sub-chambers or volumetric portions of the first chamber 4 for the passage of the fluid F1 to be treated.

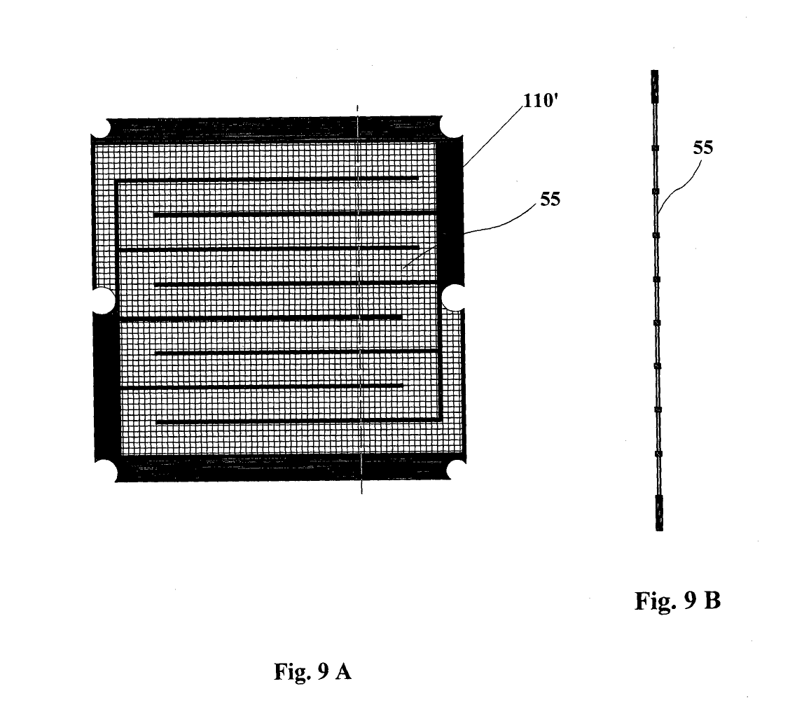

Such insulating spacers 55 can for example be constituted by a plastic net, and have the purpose of preventing short-circuits between the porous separator septa that separate the first and the second conductive plate-like elements 13, 18. Such insulating spacers 55 can optionally force the fluid F1 to follow a fixed path in a specific pattern, such as that illustrated in the enclosed FIG. 9 that bears a serpentine pattern.

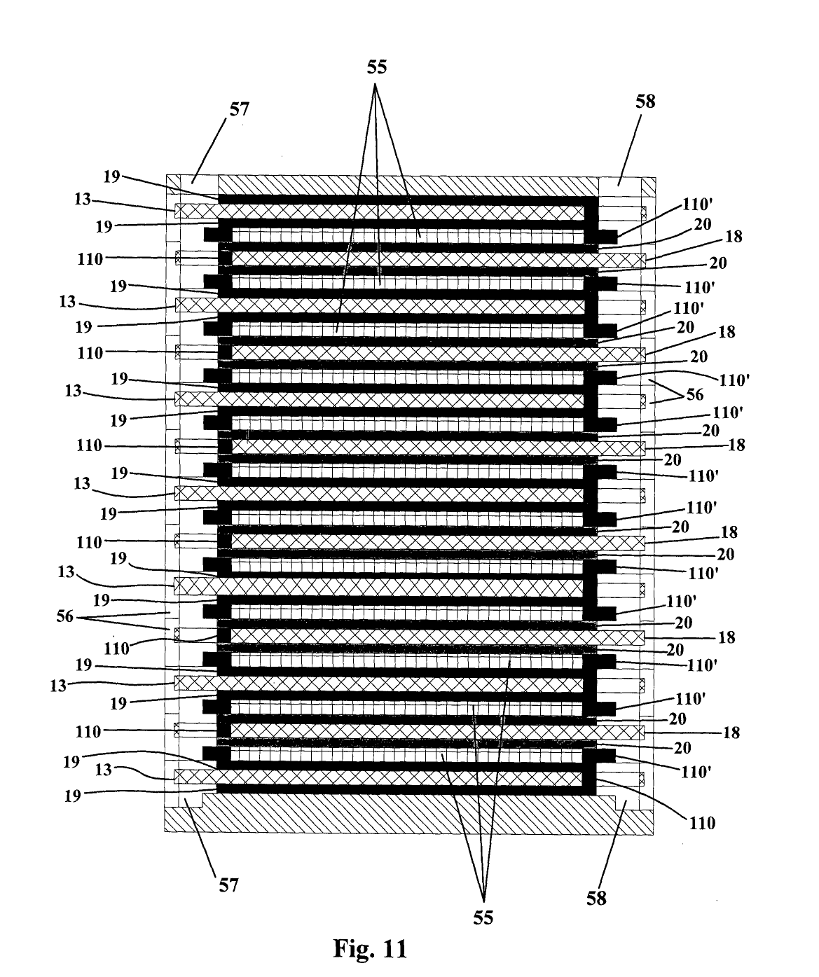

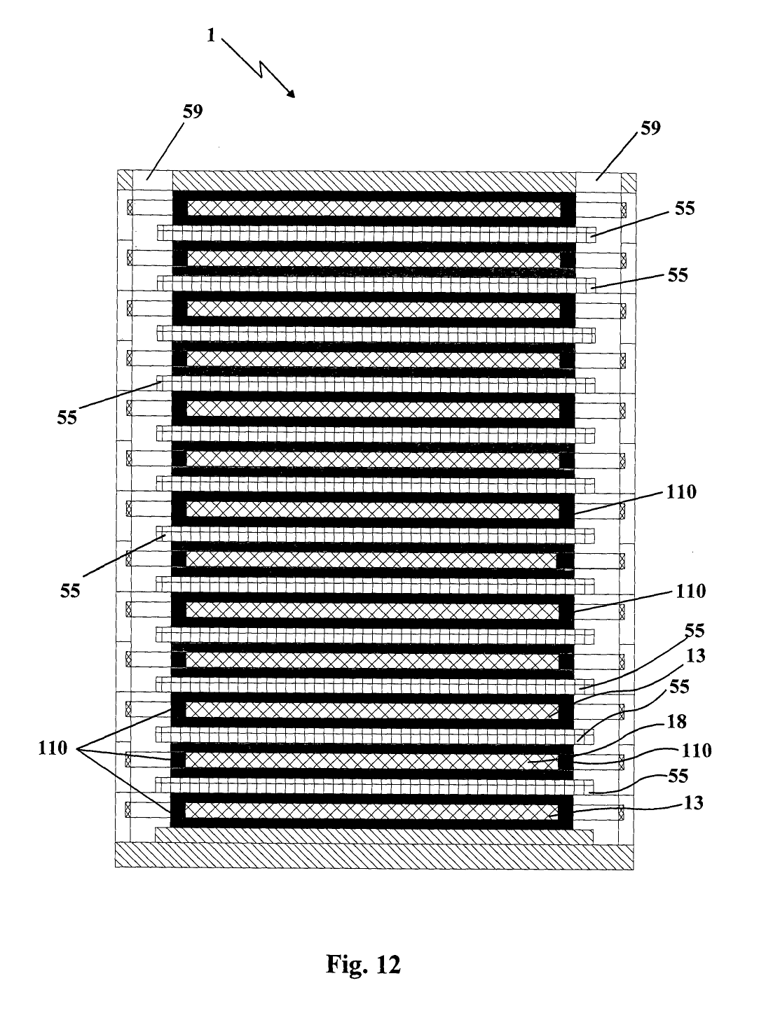

The volumetric portions of the two chambers 9, 15 for the passage of the slurries S1, S2, and of the first chamber 4 for the passage of the fluid to be treated F1, are perimetrically delimited by first peripheral frames 56 of the first cell 2, advantageously associated for example with the first and the second conductive plate-like elements 13, 18, given that the first or second septa 19, 20 and the insulating spacer septa 55 are interposed and mechanically stopped between them, as illustrated in the schematic section views of FIGS. 11 and 12.

Such frames 56 are advantageously fittingly connected to each other by means of mechanical coupling 300 obtained for example with counter-shaped reliefs and grooves obtained on the opposite faces of the same frames. The latter are also perimetrically hydraulically sealed on each other due to gaskets 110 that cover the edge of the support frames 56 of the aforesaid first and second conductive plate-like elements 13, 18.

In a preferred embodiment, a metal net (woven, cut or molded) is used in order to obtain the first and the second conductive plate-like elements 13, 18, on which a rubber gasket 110 is deposited that incorporates the net and becomes integral therewith. In this case, therefore, the molded gasket 110 becomes at the same time a support element for the various porous septa 19, 20 and spacers 55. The same gasket 110 can have an external edge, possibly more rigid, co-molded together to form the frame 56.

In accordance with the enclosed FIGS. 7 and 8, also extending from the frames 15 are conductor fins 13′, 18′ electrically connected to the respective first and second conductive plate-like elements 13, 18 and advantageously obtained in a single body with projecting portions (e.g. steel nets) adapted to obtain dry external contacts to which the power supply can be electrically connected.

More generally, the aforesaid sub-chambers of the chambers 9 and 15 each contain respective first and second conductive elements 13, 18 that can also not be plate-likes and that can each be connected to the electrical power supply by means of contacts that can be “wet” (inside the sub-chamber) or “dry” (outside the sub-chamber).

A plurality of ears 120 are extended outside and integral with each frame 56 in order to allow compacting, by means of mechanical fixing means such as screws, the stack of support frames 56 of the aforesaid first and second conductive plate-like elements 13, 18 with the first and the second septa 19, 20 as well as the insulating spacer septa 55 interposed.

The stacked frames 56 are also transversely traversed (with holes aligned on each frame 56) by inlet pipes 57, 58 and 59 and outlet pipes 57′, 58′, 59′ adapted to hydraulically connect together respectively the corresponding volumetric portions of the second, third and first chamber 9, 15, 4 for the passage of the slurries S1, S2 and the fluid to be treated F1.

In accordance with FIGS. 11 and 12, which represent two cross sections of the first cell 2 carried out along the lines A-A and B-B of FIG. 7A, the gaskets 110 are sealingly arranged between the pairs of contiguous septa 19 or 20 of the respective first and second electrodes 13, 18, at both the inlet pipes 59 of the fluid to be treated F1 and the inlet pipes 57, 58 of the opposite electrode 18, 13.

In this manner, alternatively in the succession of plates of the first cell 2, the inlet pipes 57, 58 supply the respective electrode 13 or 18 placed between the pairs of septa 19 and 20, on which the gasket 110 does not make a seal.

Analogously, provided gaskets 110′ associated with the separators 55 are sealingly arranged only between the contiguous septa 19 and 20 of contiguous sub-chambers containing opposite electrodes 13, 18 at the openings of the inlet pipes 57, 58 while they allow the passage of the fluid to be treated at the pipes 59.

Of course, without departing from the protective scope of the present patent, many different configurations can be provided for hydraulically connecting together the above-indicated sub-chambers, alternating them in a sequence that always has the fluid to be treated F1 flow into a sub-chamber (having the shape of a flattened cell) of the first chamber 4; the latter has two different sub-chambers arranged in contiguous position on the two opposite faces thereof, also in the form of flattened cells, respectively containing the first and the second conductive plate-like elements 13′, 18′ intercepted by the first and by the second circuit 12, 120 of slurry S1, S2.

Analogously, also the second cell 21 can have a configuration equivalent to that indicated above for the first cell 2, with the sub-chambers of the two cells 2, 21 assembled in a single common containment structure, e.g. made of plastic material.

More in detail, therefore (for the sake of descriptive simplicity using analogous reference numbers for the cell structure that were employed to describe the first cell, without enclosing further specific drawings since they would be entirely analogous to those enclosed for the first cell), also the third and the fourth electrodes 32, 37 of the second cell 21 are each obtained by means of a plurality of third and fourth conductive plate-like elements in particular net-like, placed in succession inside the casing 22 of the second cell 21 with alternated polarity, and they are each spaced from the respective third and fourth septa 38, 39 in order to form sub-chambers therewith, i.e. volumetric portions of the respective fourth and fifth chamber 28, 34 for the passage of the slurries S1, S2.

The sub-chambers thus formed containing the third or fourth conductive plate-like elements 32, 37 are alternatively arranged in succession in a stack, interposing between the third and the fourth contiguous septa 38, 39 for separating electrodes with opposite polarity, respectively negative and positive, the insulating spacer septa 55 in turn adapted to define, together with the aforesaid pairs of third and fourth contiguous septa 38, 39, sub-chambers i.e. volumetric portions of the sixth chamber 23 for the passage of the washing fluid F2.

The volumetric portions of the two chambers 28, 34 for the passage of the slurries S1, S2 and the sixth chamber 23 for the passage of the washing fluid F2 are perimetrically delimited by peripheral frames 56 of the second cell 21.

On such frames 56, placed as a perimeter seal on each other, the inlet pipes 57, 58 and 59 and outlet pipes 57′, 58′, 59′ are transversely obtained, adapted to hydraulically connect together respectively the corresponding volumetric portions of the fourth, fifth and sixth chamber 28, 34, 23 for the passage of the slurries S1, S2 and the washing fluid F2.

In accordance with the embodiment of the present invention, clearly illustrated in the scheme of FIG. 1B, the apparatus 1 further comprises, with respect to the embodiment of FIG. 1A, at least one third energy recovery cell 60 provided with a third containment structure 61—e.g. it too made of plastic material like the others—which contains at least three other chambers therein that are specified hereinbelow.

Such embodiment will allow recovering most of the energy spent by the first cell 2 in order to allow the corpuscles to absorb the charged particles, and it will also allow spending less energy for moving away the same charged particles, once the latter have been separated from the corpuscles, in the third cell 60.

The first, second and third containment structure 3, 22, 61 of the three cells 2, 21, 60 can be advantageously in common, even if physically maintaining separate the respective three chambers for the passage of the relative fluids.

A seventh chamber 62 of the third cell 60 is traversed by a flow of conductive fluid advantageously constituted by the same washing fluid F2 that exits from the second cell 21.

Such seventh chamber 62 is advantageously fed with the conductive fluid F2 by means of a third supply pipe 63, which is advantageously constituted by a connector tubing that connects the seventh inlet opening 64 of the seventh chamber 62 to the fourth outlet opening 27 of the sixth chamber 23 of the second cell 21.

The seventh chamber 62 is then provided with a seventh outlet opening 65 through which the washing fluid F2 is sent to a third delivery pipe 66.

An eighth chamber 67 of the third cell 60 is traversed by the first operative slurry S1, and is for such purpose provided with an eighth inlet opening 68 and an eighth outlet opening 69 connected to the first circuit 12 in which such first operative slurry S1 circulates.

Inside such eighth chamber 67, a fifth electrode 70 is housed which is positively connected to a third power supply source 71 in order to supply it with the charges released from the first corpuscles of the first slurry S1 and corresponding to those charges of the anionic particles absorbed in the second chamber 9 of the first cell 2.

A ninth chamber 72 of the third cell 60 is traversed by the second operative slurry S2, and is for such purpose provided with a ninth inlet opening 73 and a ninth outlet opening 74 connected to the second circuit 120 in which such second operative slurry S2 circulates.

Inside such ninth chamber 72, a sixth electrode 75 is housed which is negatively connected to the third power supply source 71 in order to supply it with the charges released from the second corpuscles of the second slurry S1 and corresponding to those charges of the cationic particles absorbed in the third chamber 9 of the first cell 2.

In accordance with the structural configuration described above and in accordance with the scheme of FIG. 1B, the third cell 60 is interposed in the two circuits 12 and 120 of the first and the second slurry S1, S2. More in detail, the first circuit 12 connects the second outlet opening 11 of the second chamber 9 of the first cell 2 to the eighth inlet opening 68 of the eighth chamber of the third cell 60 and then the eighth outlet opening 69 of the same eighth chamber of the third cell 60 with the fourth inlet opening 29 of the fourth chamber 28 of the second cell 21, while the second circuit 120 connects the third outlet opening 17 of the third chamber 15 of the first cell 2 to the ninth inlet opening 73 of the ninth chamber 72 of the third cell 60 and the ninth outlet opening 74 of the ninth chamber 72 of the third cell 60 to the fifth inlet opening 35 of the fifth chamber 34 of the second cell 21.

Inside the third containment structure 61 of the third cell 60, the eighth and ninth chamber 67, 72 are hydraulically separated from each other with the interposition of the seventh chamber 62. More in detail, the eighth and the ninth chamber 67, 72 are separated from the seventh chamber 62 respectively by means of a fifth septum 76 and a sixth septum 77, interposed at at least partial containment of the conduction fluid F2 that circulates in the seventh chamber 62 with respect to the slurries S1 and S2 that circulate in the eighth and in the ninth chamber 67, 72. Such fifth and sixth septum 76, 77 are respectively permeable to the passage of charges with the washing fluid that close the electric circuit produced by the charges released by the corpuscles in contact with the electrodes 70, 75.

The latter septa must however strongly limit, and preferably entirely prevent the passage of the fluids F2, S1 and S2 through them. Depending on the application provided and on the type of septa employed, a small dilution of one fluid by a contiguous one can be tolerated. It can also be provided to calibrate the circulation pressures of the fluids F2, S1 and S2 in the three chambers 62, 67, 72 in order to prevent or limit such dilutions.

Advantageously, the septa 76, 77 can be similar to those of 19 and 20 of the first cell 2, i.e. they can be selected from among: ion exchange membranes (cationic or anionic) with different functional groups; insulating porous separators or conductors such as TNT (non-woven fabric) glass fiber structures; microporous membranes such as micro/ultra/nanofiltration membranes; microporous separators with conductive polymers.

The aforesaid third cell 21 can be obtained, in a manner entirely analogous to the first and second cell 2, 21, through a configuration of plate exchanger type, with the seventh 62, eighth 67 and ninth chamber 72 obtained with a plurality of sub-chambers or volumetric portions.

Each of the latter portions contains the electrodes in the form of fifth and sixth conductive plate-like elements 70, 75 alternately arranged in succession in a stack, interposing between the fifth and sixth contiguous septa 76, 77 for the separation of electrodes with opposite polarity, respectively positive and negative, the insulating spacer septa 55; the latter are in turn adapted to define, together with the aforesaid pairs of fifth and sixth contiguous septa 76, 77, sub-chambers or volumetric portions of the seventh chamber 62 for the passage of the conduction fluid F2.

Also in this case, the volumetric portions of the two chambers 67, 72 for the passage of the slurries S1, S2 and of the seventh chamber 62 for the passage of the conduction fluid F2 are perimetrically delimited by peripheral frames 56 of the third cell 21; the latter have, transversely obtained, inlet pipes 57, 58 and 59 and outlet pipes 57′, 58′, 59′ adapted to hydraulically connect together respectively the corresponding volumetric portions of the eighth, ninth and seventh chamber 67, 72, 62 for the passage of the slurries S1, S2 and the conduction fluid F2.

Such mechanical configuration for such third cell 60—already described in detail above with reference to the other first cell 2 and second cell 21—is not repeated more in detail herein. The conductive fluid F2 is in substance constituted by a fluid capable of electrically connecting the two slurries S1, S2 by transferring charges into the eighth and ninth chamber 67, 72, thus closing the electric circuit between the relative fifth and sixth electrode 70, 75 without determining a high potential drop at their ends. The washing fluid F2 contains the charged particles absorbed from the fluid to be treated F1 with high electrical conductivity, and hence the third cell 60 is well adapted to form the electrical bridge necessary for discharging the charges of the corpuscles of the slurries S1, S2 on the respective electrodes 70, 75. This characteristic is functionally preferred since it reduces the inevitable losses due to the minimum electrical resistance offered by the washing fluid F2.

In operation, the third cell 60 allows recovering most of the energy spent in the first cell 2 for associating the corpuscles with the anionic particles and cationic particles. More in detail, the eighth chamber 67 is traversed by the first operative slurry S1 containing the first corpuscles having electrostatically associated the anionic particles assumed from the fluid to be treated F1 in the first cell 2. Such first corpuscles are then charged with electrostatic energy which they can release, balancing their positive charge in contact with the negative electrode of the eighth chamber 67 of the third cell 60; simultaneously, upon neutralization of the first corpuscles, the anionic particles are freed from their electrostatic bond with the first corpuscles in the first slurry S1, typically giving rise for example to an acidic solution.

In turn, the ninth chamber 72 is traversed by the second operative slurry S2 containing the second corpuscles having electrostatically associated the cationic particles assumed from the fluid to be treated F1 in the first cell 2. Such second corpuscles are then also charged with electrostatic energy that they can release, balancing their negative charge in contact with the positive electrode of the ninth chamber 72 of the third cell 60; simultaneously, upon neutralization of the second corpuscles, the cationic particles are freed from their electrostatic bond with the second corpuscles in the second slurry S2, typically giving rise for example to an alkaline solution.

The two slurries S1 and S2 exiting (from the openings 69, 74) from the eighth chamber 67 and ninth chamber 72 of the third cell 60 therefore have the relative first and second corpuscles substantially free of charge and the free anionic particles and cationic particles in the relative slurry, typically achieving respectively acidic and alkaline solutions.

The flow of current that is registered at the electrodes 70, 75 of the third cell 60 is reversed with respect to that of the first cell 2 for absorbing the ions, following the release of the charges at the electrodes by the corpuscles of the slurries. In such a manner, a direct voltage is obtained at the electrodes 70, 75 of the third cell. This voltage will be added to that supplied by the first power supply source 14, reducing the required power consumption.

At the outlet of the third cell 60 for energy recovery, each slurry S1, S2 will still have ions retained but no longer electrostatically adherent to the surface of the corpuscles of the slurry. At this point, these are respectively acidic and alkaline solutions inside the respective first and second slurry S1, S2.

The slurries S1 and S2 thus obtained are thus sent to the inlet (to the openings 29, 35) of the fourth 28 chamber and fifth chamber 34 of the second cell 21, where the charged particles separated from the corpuscles must only receive the energy necessary for being carried into the washing liquid, traversing the respective anionic septum 38 and cationic septum 39.

Therefore, in accordance with the present embodiment of FIG. 1B, the step of electrostatic liberation of the mobile electrodes constituted by the corpuscles of the slurries from the anionic particles and cationic particles absorbed from the liquid to be treated F1 occurs in the third cell 60 by substantially transferring to the electrodes 70, 75 nearly all of the charge previously absorbed in the first cell 2, so as to neutralize the electrostatic attraction of the corpuscles with such anionic particles and cationic particles; while the step of moving away the anionic particles and cationic particles from the porous structures of the same neutralized corpuscles, and to which the particles are thus no longer substantially electrostatically bound, occurs in the second cell 21 by means of the supply of charge with reverse polarity for moving the aforesaid anionic particles and cationic particles through the septa of semi-permeable membranes of anionic and cationic exchange 38, 39 up to the sixth chamber 23 of the second cell 21, with the consequent possibility of then removing them by means of the passage, in such sixth chamber 23, of the washing fluid F2.

The first and the third power supply source 14 and 71 can be shared, so as to recover at least part of the energy released in the third cell 60 in order to use it in the first cell 2.

Therefore, in accordance with such embodiment of FIG. 1B, the aforesaid extraction means 100 must be intended as including: the third cell 60 capable of determining the separation of the anionic particles and cationic particles from the first and from the second corpuscles; the second cell 21 for moving away the particles; as well as the washing means 200 obtained in this case by the sixth chamber 23 traversed by the washing fluid F2 and separated by means of the septa 38, 39 from the fourth and fifth chamber 28, 34.

In a further embodiment of the present invention illustrated in the FIGS. 1C and 1D, the first cell 2 is analogous to the preceding while the second cell 21 uses an electro-conductive separator 23′, i.e. a conductive diaphragm which is directly in contact on its two faces with the slurries S1, S2. It is not permeable to the ions and substantially separates the two slurries S1, S2, given that it is constituted for example by a bipolar membrane or also by a metal plate. Such conductive separator 23′ prevents the presence of the sixth cell 23, in which the conduction fluid F2 is made to flow. In addition, the washing flow F2 in the second cell 21 is also prevented, and the latter becomes more structurally simple.

The conductive separator 23′ used allows closing the electric circuit in an efficient manner, with a low electrical resistance between the electrodes 32, 37.

In accordance with the embodiments of FIGS. 1C and 1D that maintain the reference numbers of FIGS. 1A and 1B for the parts in common and in particular for the electrical connections that are therefore not repeated, the washing means 100 of the extraction means 200 comprise at least one washing tank 101, which intercepts at least one between the two circuits 12, 120 downstream of the second cell 21 for receiving the feed of at least one corresponding slurry S1, S2 through third inlet and outlet connections 102 and 103.

Such washing tank 101 is then connected to a second supply piping 104 of a washing liquid F4 and to a second discharge piping 105 for subjecting the corresponding slurry S1, S2 to a forced washing action, in particular counter-current.

Preferably, the washing tank 101 receives the slurry S1, S2 from below by means of the third inlet connection 103 and it transfers it by a fourth connection placed above the third in order to ensure the extraction of a flow of slurry, preferably from a full tank 101 or at least full up to such fourth outlet connection 104.

A same amount of slurry enters and exits from the washing tank 101 by means of the first recirculation pump 40 and/or the second recirculation pump 41 or 41′ (in the case of the embodiment of FIG. 1D, even only one pump 41′ can be provided).

Downstream of the two slurry tanks 101 (embodiment of FIG. 1C) or of the single slurry tank (embodiment of FIG. 1D), slurry compensator tanks 42 will be advantageously provided of the type already described above (and possibly also provided with a washing fluid F3) in order to define the quantity of slurry circulating in the circuits (e.g. by means of the use of optical level sensors, capacitive sensors or simple floats) as well as the operative pressure in the circuits (e.g. placing such slurry compensator tanks 42 under pressure).

In accordance with such embodiments illustrated in the FIGS. 1C, 1D, each washing tank 101 is advantageously provided with a second and a third porous filtering septum 106, 107 placed at the aforesaid second supply piping 104 and second discharge piping 105, preferably the first 106 arranged above the washing tank 101, and the second arranged below the washing tank 101.

In particular, according to the embodiment of FIG. 1C, two washing tanks 101 are provided that are separate from each other, each intended to intercept a respective circuit 12, 120 in order to wash the slurry S1, S2 of the anionic particles and cationic particles associated with the corpuscles even if no longer electrostatically bound to the latter after the passage through the second cell 21.

Advantageously, in accordance with the embodiment illustrated in FIG. 1C, the washing fluid F4 that is reused is that which has washed the first slurry S1 containing, after the passage through the first cell 2, the anionic particles washed from the first corpuscles and typically aimed to form an acidic solution capable of better washing the second slurry S2 containing the cationic particles and hence susceptible to obtaining an alkaline solution.

In this manner, therefore, the acidic solution of the washing fluid F4 formed from the washing of the first circuit 12 of slurry S1 can be sent to wash the alkaline solution of the second circuit 120 of slurry S2 that is more encrusted and subjected to easier precipitation.

According to the embodiment of FIG. 1D, the washing tank 101 operatively intercepts both circuits S1, S2 downstream of the second cell 21 for receiving the feed of the slurries S1, S2. In this case, the common washing tank 101 is supplied from the first and second circuit 12, 120 respectively coming from the third and fourth outlet respectively of the third and fourth chamber 9 and 15 of the first cell 2 with slurry washed in the washing tank 101.

The flow of water washes away, preferably counter-current, the anionic particles and cationic particles, i.e. generally the acidic and alkaline solution that reach the tank 101 after having traversed the second cell 21.

According to an advantageous characteristic of the invention, the washing liquid F4 of a first washing tank 101 of the two indicated above is sent, by means of its second discharge piping 105, to the second supply piping 104 of the second washing tank 101 in order to subject the slurry that feeds the latter second washing tank 101 to a forced washing action with the washing liquid that had previously fed the first washing tank 101 and carried away the acidic or alkaline solution from the latter.

Therefore, in accordance with such embodiments of FIGS. 1C and 1D, the aforesaid extraction means 100 must be intended as including: the second cell 21 capable of determining the separation of the anionic particles and cationic particles from the first and from the second corpuscles; as well as the washing means 200 obtained in this case by one or two washing tanks 101.

It is considered that, in accordance with the various embodiments illustrated above, the washing means 200 can provide that the flow of washing fluid flows directly in contact with the slurry or slurries in a tank 101, outside the second cell 21 (as in the FIGS. 1C and 1D), or in a sixth chamber 23 contained inside the second cell 21 and separated from the slurries S1 and S2 by means of septa 38, 39 and traversed by the washing fluid that receives, from the slurries affected by the action of an electric field, only the anionic particles and cationic particles absorbed and possibly already previously separated from the corpuscles in a third cell 60 for the recovery of energy (according to the embodiment of FIG. 1A).

Analogously, in accordance with a possible and advantageous embodiment of the present invention, the second cell 2, with only two supply fluids in accordance with FIGS. 1C and 1D, is analogously obtained in the form of a parallel plate exchanger with a configuration equivalent to that indicated above for the first cell 2 and for the second cell 21 with three supply fluids, already described above. In this case, the sixth chamber 23 obtained with the two septa 38, 39 separated by the separator 55 will be substituted in the succession of the stack from the electro-conductive separator 23′. Also in this case, the sub-chambers of the two cells 2, 21 can be assembled in a single common containment structure, e.g. made of plastic material with the supply fluids separated.

In accordance with a further embodiment of the present invention illustrated in FIG. 1E, the two circuits 12 and 120 for the circulation of the first and the second slurry 12, 120 are sent to a common washing tank 101 without the previous passage in a second cell 21. The corpuscles of the two slurries with the anionic and cationic particles absorbed are in forced contact with each other, e.g. facilitated by the turbulence of the washing action; first their charges balance each other, then they release in the washing liquid their anionic particles and cationic particles.

Such washing tank 101 receives the feed of the two slurries S1, S2 through third inlet and outlet connections 102 and 103 directly connected to the second and third outlet opening 11, 17 of the second and third chamber 9, 15 of the first cell 2. The inlet connections 102 of the two slurries in the tank can comprise emission nozzles 130, 140 advantageously directed against each other.

Analogous to the preceding washing tanks of the preceding embodiments, also the latter washing tank 101 is connected to a second supply piping 104 of a washing liquid F4 and to a second discharge piping 105 for subjecting the slurries S1, S2 to a forced washing action, in particular counter-current.

Such washing tank 101 is also advantageously provided with a second and a third porous filtering septum 106, 107 placed at the aforesaid second supply piping 104 and second discharge piping 105 and preferably arranged as follows: the first 106 above the washing tank 101, and the second below the washing tank 101.

Advantageously, in order for the corpuscles of the two slurries to be in better contact with each other and allow a more facilitated balancing of their charge, conductive elements are inserted inside the tank, in particular floating conductive elements 150 (but they could also be constituted by fixed elements such as metal nets), such as metal chips or shavings e.g. steel, titanium or another conductor material. Such floating conductive elements 150 will advantageously occupy a lower portion of the washing tank 101 due to their specific weight, so as to not enter into circulation inside the two slurry circuits through the common outlet connection 103.

A separator element can also be advantageously provided, capable of containing the floating conductive elements 150 inside a specific volume of the washing tank 101. In such case, the floating conductive elements 150 can also be relegated to the upper part of the tank 101 or in an intermediate part thereof confined in two separator elements.

Also forming the object of the present invention is a method for purifying a fluid, which in particular can employ the apparatus 1 described above in the various embodiments; for the sake of simplicity, the same reference numbers and nomenclature will be maintained hereinbelow.

The aforesaid method, according to the idea underlying the present invention, provides for the following operative steps:

A step of flow of a fluid to be treated F1 containing cationic particles and anionic particles through a first chamber 4, in particular of a first cell 2.

A step of positive electrostatic charging of the corpuscles of a first operative slurry S1 circulating in a first circuit 12 through the interception of such first slurry S1 by a positive electrode 13 in a second chamber 9, in particular of the same first cell 2, separated from the first chamber 4 by means of a first separation septum 19 permeable to the anionic particles.

Simultaneously, there is also the step of negative electrostatic charging of the corpuscles of a second operative slurry S1 circulating in a second circuit 120, through the interception of such second slurry by a negative electrode 18 in a third chamber 15, in particular of the same first cell 2, separated from the first chamber 4 by means of a second separation septum 20 permeable to the cationic particles.

Due to such association of the flows S1 with F1 and S2 with F1 separated from each other by the first septum 19 and by the second septum 20, there is the step of absorption via electrostatic attraction by the charged corpuscles of the first and second slurry S1, S2 respectively of the anionic particles and the cationic particles coming from the fluid to be treated F1.

At this point, there is a step of continuous extraction from the first and from the second circuit 12, 120 of the anionic particles and cationic particles respectively absorbed by the first operative slurry and by the second operative slurry, and sending of said regenerated slurries to the second and third chamber 9, 15.

The separation of the anionic particles from the first corpuscles of the first operative slurry S1 occurs, in accordance with the embodiment illustrated in FIG. 1B, at the passage of the first circuit 12 in a fourth chamber 28 containing a fourth negative electrode 32. Analogously, the separation of the cationic particles from the second corpuscles of the second operative slurry S2 occurs, in accordance with such embodiment of FIG. 1A, at the passage of the second circuit 120 in a fifth chamber 34 containing a fourth positive electrode 37.

In accordance with the description of the apparatus already illustrated above, in this case the fourth 28 and the fifth chamber 34 are separated from each other by means of a conductive separator 23, 23′ (whether this is a conductive diaphragm or a sixth chamber for the passage of a washing fluid F2).

The third and the fourth electrode generate, with such conductive separator 23, 23′, a closed circuit in which an electric current circulates that runs from the fourth electrode 32 associated with the second slurry S2 to the third electrode 37 associated with the first slurry S1.

The extraction step advantageously provides for the washing of the first and the second slurry S1, S2 of the corresponding first and second circuit 12, 120 for removing from the latter the anionic particles and the cationic particles electrostatically separated from the first and from the second corpuscles of the two corresponding slurries during the abovementioned steps of separation, before their resending to the second chamber 9 and third chamber 15.

Such washing step is advantageously carried out in accordance with the embodiments of FIGS. 1C, 1D in at least one washing tank 200 fed with at least one from among the first and the second circuit 12, 120 downstream of the second and third chamber 9, 15 and traversed by a washing flow, in particular counter-current advantageously constituted by water or by an aqueous solution.

In accordance with the embodiment illustrated in FIG. 1C, each slurry circuit 12, 120 is associated with its washing tank 200 in order to achieve specific steps for washing, possibly with dedicated washing fluids.

Advantageously, it can be provided to carry out the washing step of a slurry circuit (e.g. of the second circuit, the usually alkaline cationic one), by feeding with the washing flow exiting from the washing tank of a slurry circuit (i.e. for example with the washing flow that exits from the washing tank of the first slurry circuit 12 and which has acquired the anionic particles, and thus which tends to be acidic) the washing tank of the other slurry circuit (i.e. the washing tank connected to the second circuit, that of the cationic particles and usually alkaline for more easily removing the cations, simultaneously preventing the precipitation thereof).

Otherwise, the washing step can be carried out by feeding a single washing tank 200 with both the first and second slurry circuit 12, 120 as indicated in the embodiment of FIG. 1D.

In accordance with the embodiment illustrated in FIG. 1B, the conductive separator is obtained with a sixth chamber 23 interposed between the fourth chamber 28 and the fifth chamber 34 respectively by means of the interposition of a third permeable septum 38 and a fourth permeable septum 39. The action of the electric field generated by the third and fourth electrode 32, 37 is susceptible to determine the traversing respectively of the third and fourth septum 38, 39 by respectively the anionic particles and cationic particles after they have been separated from the respective first and second corpuscles. At this point, the extraction of the anionic particles and cationic particles from the sixth chamber 23 is obtained by means of a washing fluid placed to traverse it. The electrodes, if they have been power supplied, will first provide to separate the anionic particles and cationic particles from the corpuscles of the respective first and second slurry and will then determine the moving away thereof.

In accordance with the embodiment illustrated in FIG. 1B, the first and the second slurry S1, S2 are subjected, before the step of separation of the anionic particles and cationic particles by means of their passage in the fourth and fifth cell 28, 34, to a step of neutralization in which they traverse an eighth and a ninth cell 67, 72 separated from a seventh chamber 62 traversed by a conduction fluid F2, by means of a fifth and a sixth septum 76, 77, and in which they respectively contact a positive electrode 70 and a negative electrode 75 transferring at least part of the electrostatic charge absorbed in the second and third chamber 9, 15 thereto.

In accordance with the embodiment illustrated in FIG. 1E, the extraction of the anionic particles from the corpuscles of the first and second operative slurry S1, S2 occurs in a tank 200 that is directly fed from the first cell 2.

Therefore, in this case both the separation of the particles and their washing occurs in the washing tank 200 preferably with the aid of conductive elements that facilitate the step of separation of the particles by neutralizing the charges of the corpuscles.

The extraction step is in this case facilitated by a forced mixing of the two slurries aimed to bring the corpuscles in close electrical contact with each other.

The apparatus and the method thus conceived therefore reach the preset objects.

Of course, in the practical achievement of the apparatus, it can also assume shapes and configurations that are different from that illustrated above, without departing from the present protective scope.

In addition, all the details can be substituted by technically equivalent elements, and the size, shapes and materials used can be of any type in accordance with requirements.

1. Apparatus for purifying a fluid, characterized in that it comprises:
at least one first ion absorption cell, provided with a first containment structure defining therein:
at least one first chamber provided with a first inlet opening and a first outlet opening, through which a fluid to be treated flows containing cationic particles and anionic particles;
at least one second chamber containing a first electrode positively charged by a first power supply source and provided with a second inlet opening and a second outlet opening, which are intercepted by at least one first circuit continuously traversed by a first operative slurry containing first corpuscles susceptible to be electrostatically charged in contact with the first positive electrode in the second chamber of said first cell; said second chamber being separated by said first chamber by means of a first septum interposed at at least partial containment of said fluid to be treated and permeable to the passage of said anionic particles forced by said first power supply source to pass through said first permeable septum from said fluid to be treated to said first operative slurry and absorbed by the first electrostatically positively charged corpuscles of said first operative slurry;
at least one third chamber containing a second electrode negatively charged by said first power supply source and provided with a third inlet opening and a third outlet opening, which are intercepted by at least one second circuit, continuously traversed by a second operative slurry containing second corpuscles susceptible to be electrostatically charged in contact with the second negative electrode in the third chamber of said first cell; said third chamber being separated by said first chamber by means of a second septum interposed at at least partial containment of said fluid to be treated and permeable to the passage of said cationic particles forced by said first power supply source to pass through said second permeable septum from said fluid to be treated to said second operative slurry and absorbed by the second electrostatically negatively charged corpuscles of said second operative slurry;
said power supply source generating an electric current running from said first positive electrode associated with the first slurry which absorbed said negative particles to said second negative electrode associated with the second slurry which absorbed said positive particles;
extraction means for continuously removing said anionic particles and said cationic particles respectively absorbed by said first operative slurry and by said second operative slurry;
said first septum that separates said first chamber from said second chamber and said second septum that separates said first chamber from said third chamber being selected from: insulating porous separators or conductors such as TNT (non-woven fabric) glass fiber structures; microporous membranes such as micro/ultra/nanofiltration membranes; microporous separators with conductive polymers.

2. Apparatus for purifying a fluid according to claim 1, characterized in that said extraction means comprise at least one second ion separation cell provided with a second containment structure defining therein:
at least one fourth chamber containing a third electrode and provided with a fourth inlet opening and a fourth outlet opening, which are intercepted by said first circuit downstream of said second chamber and containing said first corpuscles with said anionic particles absorbed;
at least one fifth chamber containing a fourth electrode and provided with a fifth inlet opening and a fifth outlet opening, which are intercepted by said second circuit downstream of said third chamber and containing said second corpuscles with said cationic particles absorbed;
at least one conductive separator interposed between said fourth and fifth chamber; said third electrode and fourth electrode electrostatically separating said first and second corpuscles respectively from said anionic particles and from said cationic particles, respectively in contact with said first and second slurry, generating with said conductive separator an electric current running from said fourth electrode associated with said second slurry to said third electrode associated with said first slurry;
washing means for removing said anionic particles and said cationic particles electrostatically separated from said first and second corpuscles of said first and second slurry.

3. Apparatus for purifying a fluid according to claim 2, characterized in that said conductive separator is a conductive diaphragm impermeable to the ions, in particular a bipolar membrane or a metal plate.

4. Apparatus for purifying a fluid according to claim 1, characterized in that said washing means comprise at least one washing tank, which intercepts at least one of said first and second circuit downstream of said second cell for receiving the feed of at least one corresponding slurry between said first and second slurry through third inlet and outlet connections; said at least one washing tank being connected to a second supply piping of a washing liquid and to a second discharge piping for subjecting said corresponding slurry to a forced washing action, in particular counter-current.

5. Apparatus for purifying a fluid according to claim 4, characterized in that said extraction means comprise at least one second ion separation cell provided with a second containment structure defining therein:
at least one fourth chamber containing a third electrode and provided with a fourth inlet opening and a fourth outlet opening, which are intercepted by said first circuit downstream of said second chamber and containing said first corpuscles with said anionic particles absorbed;
at least one fifth chamber containing a fourth electrode and provided with a fifth inlet opening and a fifth outlet opening, which are intercepted by said second circuit downstream of said third chamber and containing said second corpuscles with said cationic particles absorbed;
at least one conductive separator interposed between said fourth and fifth chamber; said third electrode and fourth electrode electrostatically separating said first and second corpuscles respectively from said anionic particles and from said cationic particles, respectively in contact with said first and second slurry, generating with said conductive separator an electric current running from said fourth electrode associated with said second slurry to said third electrode associated with said first slurry;
washing means for removing said anionic particles and said cationic particles electrostatically separated from said first and second corpuscles of said first and second slurry;
and wherein said washing tank intercepts both said first and second circuit downstream of said second cell for receiving the feed of said slurry, said washing tank feeding said first and second circuit respectively said third and fourth chamber of said first cell with slurry washed in said washing tank.

6. Apparatus for purifying a fluid according to claim 4, characterized in that it comprises two washing tanks, each of which placed to intercept a circuit of said first and second slurry; the washing liquid of at least one first washing tank being sent by means of said second discharge piping to the second supply piping of the second washing tank for subjecting the slurry that feeds the latter second washing tank to a forced washing action with the washing liquid that feeds the first washing tank.

7. Apparatus for purifying a fluid according to claim 1, characterized in that said washing means comprise at least one washing tank, which intercepts both said first and second circuit downstream of said first cell, receiving the feed of said first and second slurry respectively from the second outlet opening of said second chamber and from the third outlet opening of said third chamber, and feeding with said respective first and second slurry, regenerated downstream of the washing tank, the second inlet opening of said second chamber and the third inlet opening of said third chamber; said at least one washing tank being connected to a second supply piping of a washing liquid and to a second discharge piping for subjecting said slurries to a forced washing action, in particular counter-current.

8. Apparatus for purifying a fluid according to claim 7, characterized in that said washing tank contains conductive elements, in particular in the form of floating metal elements.

9. Apparatus for purifying a fluid according to claim 1, characterized in that said conductive separator is obtained with a sixth chamber provided with a sixth inlet opening and a sixth outlet opening, through which a washing fluid flows, and separated from said fourth and fifth chamber respectively by means of a third septum and a fourth septum, interposed at at least partial containment of said fluid to be treated, respectively permeable to at least said anionic particles and to said cationic particles and in particular respectively obtained with an anionic membrane and a cationic membrane; the first corpuscles of said first slurry circuit with said anionic particles absorbed from said fluid to be treated being susceptible to release said anionic particles themselves to said washing fluid following the action of the electric field produced between said third electrode and fourth electrode;
the second corpuscles of said second slurry circuit with said cationic particles absorbed from said fluid to be treated being susceptible to release said cationic particles to said washing fluid following the action of the electric field produced between said third electrode and fourth electrode.

10. (canceled)

11. Apparatus for purifying a fluid according to claim 1, characterized in that said first circuit and said second circuit are respectively intercepted by a first and a second slurry compensator tank by means of first and second inlet and outlet connections.

12. Apparatus for purifying a fluid according to claim 10, characterized in that said first and second slurry compensator tank are each provided with at least one porous filtering septum susceptible to retain respectively said first corpuscles and said second corpuscles of greater size than a predetermined value; said first and second slurry compensator tank each being connected to a first supply piping of washing liquid by means of a third valve and to a first discharge piping by means of a fourth valve for subjecting the slurry contained in said first and second compensator tank to a forced washing action.

13. (canceled)

14. Apparatus for purifying a fluid according to claim 1, characterized in that said first circuit and said second circuit are respectively intercepted by first and second circulation means respectively of said first and second slurry and wherein said apparatus also comprises a conductivity meter placed to intercept the treated fluid exiting from the first chamber of said cell; and a logic control unit in communication with said first and second circulation means, which compares a conductivity value presettable therein with the greater or smaller value detected by said conductivity meter and correspondingly controls an increase or decrease of the circulation speed of said first and second slurry by means of said first and second circulation means.

15. Apparatus for purifying a fluid according to claim 1, characterized in that said first cell is obtained in the form of parallel plate exchanger with the first and the second electrodes each provided with a plurality of first and second conductive plate-like elements, in particular net-like, placed in succession inside the casing of the first cell with alternated polarity, and they are each spaced from the respective first and second septa in order to form therewith volumetric portions of the respective second and third slurry passage chamber; first spacer septa being interposed between the first and the second contiguous septa in order to define volumetric portions of the first passage chamber of the fluid to be treated; the volumetric portions of the passage chambers for the slurry and the fluid to be treated being perimetrically delimited by first peripheral frames with open pipes obtained respectively on the respective volumetric portions of the chambers.

16. Apparatus for purifying a fluid according to claim 9, characterized in that said extraction means comprise at least one second ion separation cell provided with a second containment structure defining therein:
at least one fourth chamber containing a third electrode and provided with a fourth inlet opening and a fourth outlet opening, which are intercepted by said first circuit downstream of said second chamber and containing said first corpuscles with said anionic particles absorbed;
at least one fifth chamber containing a fourth electrode and provided with a fifth inlet opening and a fifth outlet opening, which are intercepted by said second circuit downstream of said third chamber and containing said second corpuscles with said cationic particles absorbed;
at least one conductive separator interposed between said fourth and fifth chamber; said third electrode and fourth electrode electrostatically separating said first and second corpuscles respectively from said anionic particles and from said cationic particles, respectively in contact with said first and second slurry, generating with said conductive separator an electric current running from said fourth electrode associated with said second slurry to said third electrode associated with said first slurry;
washing means for removing said anionic particles and said cationic particles electrostatically separated from said first and second corpuscles of said first and second slurry,
wherein said second cell is obtained in the form of parallel plate exchanger with the third and the fourth electrodes each provided with a plurality of third and fourth conductive plate-like elements, in particular net-like, placed in succession inside the casing of the second cell with alternated polarity, and they are each spaced from the respective third and fourth septa in order to form volumetric portions therewith of the respective fourth and fifth slurry passage chamber; second spacer septa being interposed between the third and fourth contiguous septa in order to define volumetric portions of the sixth passage chamber of the washing fluid; the volumetric portions of the passage chambers for the slurry and the washing fluid being perimetrically delimited by second peripheral frames with open pipes obtained respectively on the respective volumetric portions of the chambers.

17. Apparatus for purifying a fluid according to claim 2, characterized in that said second cell is obtained in the form of parallel plate exchanger with the third and the fourth electrodes of said second cell each provided with a plurality of third and fourth conductive plate-like elements, in particular net-like, placed in succession inside the casing of the second cell with alternated polarity, and they are spaced from each other with the interposition of a conductive separator; there being defined, between pairs of said successive conductive separators, alternated volumetric portions of said respective fourth and fifth slurry passage chamber, perimetrically delimited by second peripheral frames with open pipes obtained respectively on the respective volumetric portions of the chambers.

18. Apparatus for purifying a fluid according to claim 9, characterized in that it further comprises at least one third energy recovery cell containing therein:
at least one seventh chamber provided with a seventh inlet opening and a seventh outlet opening, through which a conductive fluid flows;
at least one eighth chamber provided with an eighth inlet opening and an eighth outlet opening containing at least one third electrode positively connected to a third power supply source;
at least one ninth chamber provided with a ninth inlet opening and a ninth outlet opening containing a fourth electrode negatively connected to said third power supply source;
said seventh chamber being separated by said eighth and ninth chamber respectively by means of a fifth septum and a sixth septum, interposed at at least partial containment of said conduction fluid and susceptible to electrically connect the first slurry of said first circuit to the second slurry of said second circuit;
said third energy recovery cell intercepting said first circuit with the eighth inlet opening of the eighth chamber connected to the second outlet opening of the second chamber of said first cell and with said eighth outlet opening of the eighth chamber connected to the fourth inlet opening of the fourth chamber of said second cell, and intercepting said second circuit with the ninth inlet opening of the ninth chamber connected to the third outlet opening of the third chamber of said first cell and with said ninth outlet opening of the ninth chamber connected to the fifth inlet opening of the fifth chamber of said second cell;
said eighth chamber being traversed by the first operative slurry containing the first corpuscles with said anionic particles electrostatically associated, said first corpuscles being susceptible to balance the positive electrostatic charge thereof in contact with the negative electrode in the eighth chamber of said third cell by releasing said anionic particles in said first slurry;
said ninth chamber being traversed by the second operative slurry containing the second corpuscles with said cationic particles electrostatically associated, said second corpuscles being susceptible to balance the negative electrostatic charge thereof in contact with the positive electrode in the ninth chamber of said third cell by releasing said cationic particles in said second slurry.

19. Apparatus for purifying a fluid according to claim 18, characterized in that the conductive fluid that traverses through the seventh chamber of said third cell from the seventh inlet opening thereof to the seventh outlet opening thereof is the washing fluid that traverses through the sixth chamber of said second cell from the sixth inlet opening thereof to the sixth outlet opening thereof; at least one connector being provided for connecting the sixth outlet opening of the sixth chamber of said second cell to the seventh inlet opening of the seventh chamber of said third cell.

20. Method for purifying a fluid, in particular by means of an apparatus according to claim 1, characterized in that it comprises:
flow of a fluid to be treated containing cationic particles and anionic particles through a first chamber;
positive electrostatic charging of the corpuscles of a first operative slurry circulating in a first circuit intercepted by a first electrode, positively charged by a first power supply source, in a second chamber separated from said first chamber by a first separation septum permeable to said anionic particles;
negative electrostatic charging of the corpuscles of a second operative slurry circulating in a second circuit intercepted by a second electrode, negatively charged by said first power supply source, in a third chamber separated from said first chamber by a second separation septum permeable to said cationic particles;
said first septum that separates said first chamber from said second chamber and said second septum that separates said first chamber from said third chamber being selected from: insulating porous separators or conductors such as TNT (non-woven fabric) glass fiber structures; microporous membranes such as micro/ultra/nanofiltration membranes; microporous separators with conductive polymers;
electrostatic attraction absorption by the charged corpuscles of said first and second slurry respectively of anionic particles and cationic particles of said fluid to be treated;
continuous extraction from said first and second circuit of said anionic particles and cationic particles respectively absorbed from said first operative slurry and from said second operative slurry, and sending of said regenerated slurries to said second and third chamber.

21. Method for purifying a fluid according to claim 20, characterized in that said extraction step provides for:
the separation of said anionic particles from the first corpuscles of said first operative slurry at the passage of the first circuit in a fourth chamber containing a fourth negative electrode;
the separation of said cationic particles from the second corpuscles of said second operative slurry at the passage of the second circuit in a fifth chamber containing a fourth positive electrode; said fourth and fifth chamber being separated from each other by means of a conductive separator; said third and fourth electrode generating with said conductive separator an electric current running from said fourth electrode associated with said second slurry to said third electrode associated with said first slurry.

22. Method for purifying a fluid according to claim 20, characterized in that said extraction step provides for the washing of the first and the second slurry of said first and second circuit for removing from the latter said anionic particles and said cationic particles from said first and second corpuscles of said first and second slurry before the sending thereof to said second and third chamber.

23. Method for purifying a fluid according to claim 20, characterized in that said washing step is carried out in at least one washing tank fed with at least one of said first and second circuit downstream of said second and third chamber; and traversed by at least one washing flow, in particular counter-current.

24. Method for purifying a fluid according to claim 23, characterized in that said washing step is carried out by feeding said washing tank with both said first and second slurry circuit.

25. Method for purifying a fluid according to claim 23, characterized in that said washing step is carried out by feeding, with the washing flow exiting from the washing tank of a slurry circuit, the washing tank of the other slurry circuit.

26. Method for purifying a fluid according to claim 20, characterized in that said conductive separator is obtained with a sixth chamber interposed between said fourth chamber and fifth chamber respectively by means of the interposition of a third permeable septum and a fourth permeable septum; the action of the electric field generated by said third and fourth electrode determining the traversing respectively of said third and fourth septum of said anionic particles and cationic particles, separated from the respective first and second corpuscles; the extraction of said anionic particles and cationic particles in said sixth chamber being obtained by means of a washing fluid placed to traverse said sixth chamber.

27. Method for purifying a fluid according to claim 26, characterized in that said first and second slurry are subjected, before the step of separating said anionic particles and cationic particles by means of their passage in said fourth and fifth cell, to a step of neutralization in which they traverse an eighth and a ninth cell separated from a seventh chamber traversed by a conduction fluid, by means of a fifth and a sixth septum, and in which they respectively contact a positive electrode and a negative electrode by transferring at least part of the electrostatic charge accumulated in said second and third chamber thereto.
